(19) United States
(12) Patent Application Publication
(10) Pub. No.: US 2021/0017977 A1
(43) Pub. Date: Jan. 21, 2021

(54) AIR BLOWING DEVICE

(71) Applicant: DENSO CORPORATION, Kariya-city (JP)

(72) Inventors: Tatsuya YOSHIDA, Kariya-city (JP); Masaharu SAKAI, Kariya-city (JP); Jun YAMAOKA, Kariya-city (JP); Hidetaka NOMOTO, Kariya-city (JP); Etsuro YOSHINO, Nisshin-city (JP); Yasuhiro TAKEUCHI, Nisshin-city (JP)

(21) Appl. No.: 16/931,486

(22) Filed: Jul. 17, 2020

(30) Foreign Application Priority Data
Jul. 19, 2019 (JP) 2019-133464

(51) Int. Cl. F04B 45/06

(52) U.S. Cl. CPC F04B 45/06

(57) ABSTRACT

An air blowing device includes a duct portion and a passage variable device. The duct portion forms a main passage through which an air flow passes, and an outlet is defined downstream of the main passage to blow out the air flow. The passage variable device is configured to change a passage area of the main passage so that the air flow becomes a pulsating flow and is blown out from the outlet.

### CROSS REFERENCE TO RELATED APPLICATION

This application is based on Japanese Patent Application No. 2019-133464 filed on Jul. 19, 2019, the disclosure of which is incorporated herein by reference in its entirety.

### TECHNICAL FIELD

The present disclosure relates to an air blowing device that blows out a flow of air.

### BACKGROUND

An air blowing device includes a multi-nozzle outlet, in which plural nozzles are arranged close to each other so that their outlet surfaces are flush with each other.

### SUMMARY

According to an aspect of the present disclosure, an air blowing device includes a duct portion and a passage variable device. The duct portion forms a main passage through which an air flow passes, and has an outlet downstream of the main passage to blow out the air flow. The passage variable device is able to change the passage area of the main passage so that the air flow becomes a pulsating flow and is blown out from the outlet.

According to another aspect of the present disclosure, an air blowing device includes a duct portion and a passage variable device. The duct portion forms a main passage through which an air flow passes and plural branch passages branched from the main passage. An outlet is opened at a downstream end of the respective branch passages, for blowing out the airflow. The passage variable device is able to change the passage area of at least a part of the branch passages so that the air flow becomes a pulsating flow and is blown out from the outlet.

### BRIEF DESCRIPTION OF DRAWINGS

FIG. 1 is a schematic diagram of an air conditioner for a vehicle, to which an air blowing device according to a first embodiment is applied.

FIG. 2 is a schematic perspective view of the air blowing device according to the first embodiment.

FIG. 3 is a schematic cross-sectional view of the air blowing device according to the first embodiment.

FIG. 4 is an explanatory diagram illustrating a relationship between a passage area in a duct portion and a velocity of a main stream of an airflow blown out from an outlet.

FIG. 5 is an explanatory diagram illustrating an air flow blown from an outlet of an air blowing device of a comparative example,

FIG. 6 is an explanatory diagram illustrating an air flow blown from an outlet when the passage area is large.

FIG. 7 is an explanatory diagram illustrating an air flow blown from an outlet when the passage area is small.

FIG. 8 is an explanatory diagram illustrating an air flow blown from the outlet of the air blowing device of the first embodiment.

FIG. 9 is an explanatory diagram illustrating a velocity distribution of the air flow blown out from the outlet of the air blowing device of the first embodiment.

FIG. 10 is a schematic diagram illustrating an air blowing device according to a second embodiment in which the passage area is large.

FIG. 11 is a schematic diagram illustrating the air blowing device according to the second embodiment in which the passage area is small.

FIG. 12 is a schematic diagram illustrating an air blowing device according to a third embodiment in which the passage area is large.

FIG. 13 is a schematic diagram illustrating the air blowing device according to the third embodiment in which the passage area is small.

FIG. 14 is a schematic cross-sectional view of an air blowing device according to a fourth embodiment.

FIG. 15 is a schematic diagram illustrating an air blowing device according to a fifth embodiment in which the passage area is large.

FIG. 16 is a schematic diagram illustrating the air blowing device according to the fifth embodiment in which the passage area is small.

FIG. 17 is an explanatory diagram illustrating a pressing portion of the air blowing device according to the fifth embodiment.

FIG. 18 is a schematic diagram illustrating an air blowing device according to a modification of the fifth embodiment in which the passage area is large.

FIG. 19 is a schematic diagram illustrating the air blowing device according to the modification of the fifth embodiment in which the passage area is small.

FIG. 20 is a schematic diagram illustrating an air blowing device according to a sixth embodiment in which the passage area is large.

FIG. 21 is a schematic diagram illustrating the air blowing device according to the sixth embodiment in which the passage area is small.

FIG. 22 is a schematic front view of an air blowing device according to the sixth embodiment.

FIG. 23 is a schematic front view illustrating an air blowing device according to a first modification of the sixth embodiment.

FIG. 24 is a schematic front view illustrating an air blowing device according to a second modification of the sixth embodiment.

FIG. 25 is a schematic front view illustrating an air blowing device according to a third modification of the sixth embodiment.

FIG. 26 is a schematic front view of an air blowing device according to a seventh embodiment.

FIG. 27 is a schematic perspective view illustrating a vortex generator of the air blowing device according to the seventh embodiment.

FIG. 28 is a schematic perspective view illustrating a first modification of the vortex generator.

FIG. 29 is a schematic perspective view illustrating a second modification of the vortex generator,

FIG. 30 is a schematic perspective view illustrating a third modification of the vortex generator.

FIG. 31 is a schematic diagram illustrating an air blowing device according to an eighth embodiment in which the passage area is large.

FIG. 32 is a schematic diagram illustrating the air blowing device according to the eighth embodiment in which the passage area is small.

FIG. 33 is a schematic diagram illustrating an air blowing device according to a ninth embodiment in which the passage area is large.

FIG. 34 is a schematic diagram illustrating the air blowing device according to the ninth embodiment in which the passage area is small.

FIG. 35 is a schematic perspective view of the air blowing device according to the ninth embodiment.

FIG. 36 is a schematic front view of the air blowing device according to the ninth embodiment.

FIG. 37 is a schematic cross-sectional view of an air blowing device according to a tenth embodiment.

FIG. 38 is an explanatory diagram illustrating a change in the passage area of each branch passage over time.

FIG. 39 is a schematic diagram illustrating an air blowing device according to an eleventh embodiment in which an air flow passes through a first branch pipe.

FIG. 40 is a schematic diagram illustrating the air blowing device according to the eleventh embodiment in which an air flow passes through a second branch pipe.

FIG. 41 is a schematic diagram illustrating an air blowing device according to a twelfth embodiment in which an air flow passes through a first branch pipe.

FIG. 42 is a schematic diagram illustrating the air blowing device according to the twelfth embodiment in which an airflow passes through a second branch pipe.

FIG. 43 is a schematic diagram illustrating an air blowing device according to a thirteenth embodiment in which an air flow passes through a first branch pipe.

FIG. 44 is a schematic diagram illustrating the air blowing device according to the thirteenth embodiment in which an air flow passes through a second branch pipe.

FIG. 45 is a cross-sectional view taken along a line XLV-XLV in FIG. 43.

FIG. 46 is a cross-sectional view taken along a line XLVI-XLVI in FIG. 44.

### DETAILED DESCRIPTION

To begin with, examples of relevant techniques will be described. An air blowing device has a multi-nozzle outlet, in which plural nozzles are arranged close to each other so that their outlet surfaces are flush with each other.

A friction occurs between air blowing out of the multi-nozzle outlet and stationary fluid such as air. The friction causes a vortex (e.g., lateral vortex) with an axial direction orthogonal to a main stream of the air flow. Specifically, at the downstream of the outlet, lateral vortices that are opposite to each other in the flow direction are alternately generated so as to form a staggered flow. When such a vortex is generated around the main stream, a meandering flow is formed downstream of the outlet due to the interference between the main stream and the vortex. When the meandering flow is formed downstream of the outlet, the air flow is diffused, and the distance from the outlet to a position where the air flow can reach is significantly shortened. This is a matter found after the study by the present inventors.

The present disclosure provides an air blowing device capable of increasing the distance from the outlet to a position where the air flow can reach.

According to an aspect of the present disclosure, an air blowing device includes a duct portion and a passage variable device. The duct portion forms a main passage through which an air flow passes, and has an outlet downstream of the main passage to blow out the air flow. The passage variable device is able to change the passage area of the main passage so that the air flow becomes a pulsating flow and is blown out from the outlet.

Accordingly, when the passage area of the main passage is changed by the passage variable device, the air flow is blown out as a pulsating flow from the outlet. When the air flow blown out from the outlet becomes a pulsating flow, the position, size, etc. of a lateral vortex generated downstream of the outlet change. Therefore, it becomes difficult for a staggered vortex to be formed downstream of the outlet, and it is possible to restrict the air flow from becoming a meandering flow downstream of the outlet.

Thus, according to the air blowing device, it is possible to lengthen the distance from the outlet to the position where the air flow reaches. The “pulsating flow” is a flow with periodic or irregular fluctuations. The “pulsating flow” is not limited to a flow in which the flow direction is constant, but also includes a flow in which the flow direction is reversed.

According to another aspect of the present disclosure, an air blowing device includes a duct portion and a passage variable device. The duct portion forms a main passage through which an air flow passes and plural branch passages branched from the main passage. An outlet is opened at a downstream end of the respective branch passages, for blowing out the airflow. The passage variable device is able to change the passage area of at least a part of the branch passages so that the air flow becomes a pulsating flow and is blown out from the outlet.

Accordingly, the air flow is blown out as a pulsating flow from the outlet by changing the passage area of the branch passage by the passage variable device. When the air flow blown out from the outlet becomes a pulsating flow, the position, size, etc. of a lateral vortex generated downstream of the outlet change. Therefore, it becomes difficult for a staggered vortex to be formed downstream of the outlet, and it is possible to restrict the air flow from becoming a meandering flow downstream of the outlet. Thus, according to the air blowing device, it is possible to lengthen the distance from the outlet to the position where the air flow reaches.

A reference numeral in parentheses attached to each component or the like indicates an example of correspondence between the component or the like and specific component or the like described in embodiments below.

Hereinafter, embodiments of the present disclosure will be described with reference to the drawings. In the following embodiments, portions that are the same as or equivalent to those described in the preceding embodiments are denoted by the same reference numerals, and a description of the same or equivalent portions may be omitted. In addition, when only a part of the components is described in the embodiment, the components described in the preceding embodiment can be applied to other parts of the components. The following embodiments may be partially combined with each other even if such a combination is not explicitly described as long as there is no disadvantage with respect to such a combination.

### First Embodiment

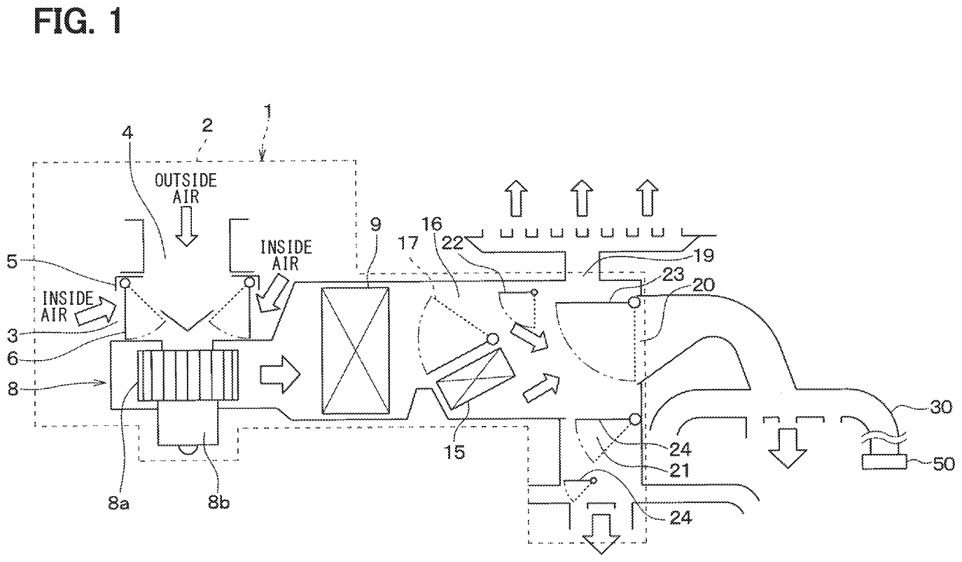

A first embodiment will be described with reference to FIGS. 1 to 9. In the present embodiment, an air blowing device 50 is applied to an indoor air conditioning unit 1 that conditions air for a vehicle. As shown in FIG. 1, the air blowing device 50 is connected to the indoor air conditioning unit 1 via a duct 30.

The indoor air conditioning unit 1 is arranged inside the instrument panel located at the most front in the cabin. The indoor air conditioning unit 1 has a case 2 that forms an outer shell. An air passage is formed inside the case 2 to blow air toward the cabin.

An inside/outside air switching box 5 having an inside air inlet 3 and an outside air inlet 4 is arranged at the most upstream part of the air passage of the case 2. An inside/outside air switching door 6 is rotatably arranged in the inside/outside air switching box 5. The inside/outside air switching door 6 switches between an inside air mode in which air in the cabin is introduced through the inside air inlet 3 and an outside air mode in which outside air is introduced through the outside air inlet 4. The inside/outside air switching door 6 is driven by a servo motor (not shown).

An electric blower 8 for generating an air flow toward the cabin is arranged downstream of the inside/outside air switching box 5. The blower 8 has a centrifugal blower fan 8a and a motor 8b for driving the blower fan 8a.

An evaporator 9 that cools the air flowing in the case 2 is arranged downstream of the blower 8. The evaporator 9 is a heat exchanger for cooling the air blown out of the blower 8. The evaporator 9 is one of components of a vapor compression refrigeration cycle.

A heater core 15 that heats the air flowing in the case 2 is arranged downstream of the evaporator 9, in the indoor air conditioning unit 1. The heater core 15 is a heat exchanger that uses the hot water of the vehicle engine as a heat source to heat the cold air that has passed through the evaporator 9. A bypass passage 16 is formed next to the heater core 15, and air bypassing the heater core 15 flows through the bypass passage 16.

An air mix door 17 is rotatably arranged between the evaporator 9 and the heater core 15. The air mix door 17 is driven by a servo motor (not shown), and its opening can be continuously adjusted. The ratio of the amount of warm air passing through the heater core 15 to the amount of cold air passing through the bypass passage 16 is adjusted by the opening degree of the air mix door 17. As a result, the temperature of the air blown into the cabin is adjusted.

A defroster opening 19 for blowing out the conditioned air toward the windshield, a face opening 20 for blowing out the conditioned air toward the face of a passenger, and a foot opening 21 for blowing out the conditioned air toward the feet of a passenger are provided at the most downstream part of the air passage in the case 2.

A defroster door 22, a face door 23, and a foot door 24 are rotatably arranged upstream of the defroster opening 19, the face opening 20, and the foot opening 21, respectively. The defroster door 22, the face door 23, and the foot door 24 are opened/closed by a common servo motor via a link mechanism (not shown).

In recent years, the instrument panel has been required to be thin in the vertical direction of the vehicle from the viewpoint of the size and the design of the cabin. In addition, the instrument panel tends to be installed with a large-sized information device for notifying various information indicating a driving state of the vehicle at a central portion in the vehicle width direction or at a location facing the passenger in the vehicle front-rear direction.

Therefore, it can be considered to make the outlet thin for the indoor air conditioning unit 1. However, if the outlet is made thin, a lateral vortex is generated downstream of the outlet, and a core of the air flow blown out from the outlet is easily broken by the lateral vortex. In this case, the distance from the outlet to the position where the air flow arrives becomes short in the cabin.

According to the indoor air conditioning unit 1 of the present embodiment, the air blowing device 50 for increasing the distance is connected to the face opening 20 of the case 2 via the duct 30. The air whose temperature is adjusted by the indoor air conditioning unit 1 is blown into the cabin through the case 2, the duct 30 and the air blowing device 50. In the present embodiment, the air blowing device 50 blows out the air flow into the cabin of the vehicle.

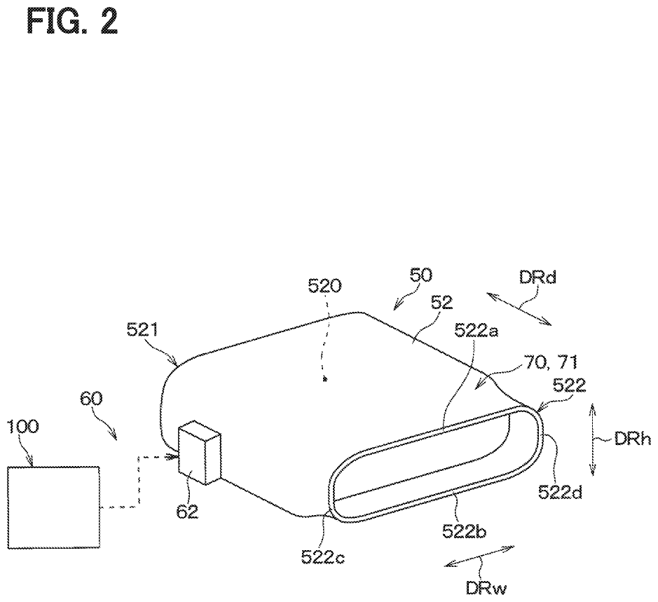

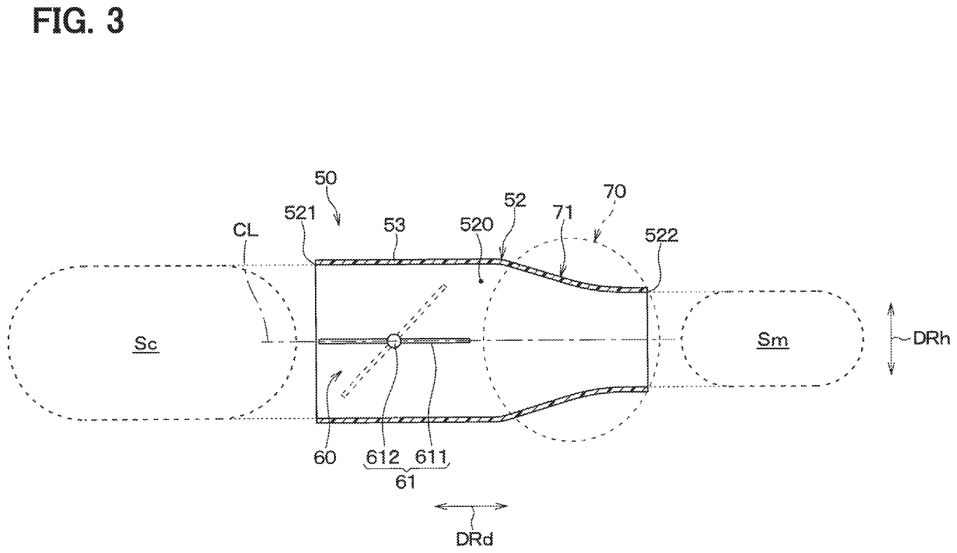

Hereinafter, the configuration of the air blowing device 50 will be described with reference to FIGS. 2 and 3. As shown in FIG. 2, the air blowing device 50 includes a duct portion 52, a passage variable device 60, and a guiding structure 70. The duct portion 52 is made of resin. Although not shown, the duct portion 52 is connected to the indoor air conditioning unit 1 shown in FIG. 1.

The duct portion 52 is a passage forming part that forms an air passage 520 through which the air flow passes. The duct portion 52 has a tubular shape with an oval cross section. The duct portion 52 has an inlet 521 for introducing the conditioned air into the air passage 520, and the inlet 521 is opened at a site upstream of the air passage 520 in the air flow. Further, the duct portion 52 has an outlet 522 for blowing out the air flow toward the cabin at a site downstream of the air passage 520 in the airflow. In the present embodiment, the air passage 520 of the duct portion 52 corresponds to a main passage through which the air flow passes.

The open shape of the outlet 522 is flat. Specifically, the open shape of the outlet 522 has straight long edges 522a and 522b opposed to each other with a predetermined space, and arc short edges 522c and 522d that connect the long edges 522a and 522b. The short edges 522c and 522d have a larger interval than the long edges 522a and 522b.

In the present embodiment, the longitudinal direction of the opening of the outlet 522 is referred to as a width direction DRw, the lateral direction of the opening of the outlet 522 is referred to as a height direction DRh, and the open direction of the outlet 522 is referred to as a depth direction DRd. In the present embodiment, the size of the air passage 520 in the height direction DRh may be referred to as a passage height, and the size of the air passage 520 in the width direction DRw may be referred to as a passage width. The longitudinal direction of the outlet 522 is an extending direction of the long edge 522a, 522b of the outlet 522. The lateral direction of the outlet 522 is an extending direction of the short edge 522c, 522d of the outlet 522. The depth direction DRd is along the central axis CL of the air passage 520.

The duct portion 52 has a passage height smaller than the passage width. In the duct portion 52, the passage height and the passage width are larger at the inlet 521 than at the outlet 522. The duct portion 52 is provided with the passage variable device 60 that changes the passage area of the air passage 520 so that the air flow becomes a pulsating flow and is blown out from the outlet 522.

The duct portion 52 has a passage variable portion 53, between the inlet 521 and the outlet 522, where the passage area is changed by the passage variable device 60. The passage variable portion 53 is set closer to the inlet 521 than the outlet 522.

The passage variable device 60 includes an adjustment door 61 for adjusting the passage area of the air passage 520, a drive unit 62 that drives the adjustment door 61, and a door control unit 100, In the passage variable device 60, the adjustment door 61 is installed inside the duct portion 52, and the drive part 62 is installed outside the duct portion 52.

The adjustment door 61 is a rotary door having a plate-shaped door portion 611 and a door shaft 612 connected to a substantially central part of the door portion 611. The adjustment door 61 has a first posture in which the plate surface of the door portion 611 extends parallel to the air passage 520 and a second posture in which the plate surface of the door portion 611 intersects the extending direction of the air passage 520.

The air passage 520 has the maximum passage area when the adjustment door 61 is in the first posture. When the adjustment door 61 is in the second posture, a part of the air passage 520 is closed by the door portion 611, so that the passage area is reduced. The first posture is a non-restricted posture in which the passage area of the air passage 520 is not limited by the adjustment door 61. The second posture is a limiting posture by which the passage area of the air passage 520 is limited by the adjustment door 61.

The drive unit 62 is provided for changing the posture of the adjustment door 61, The drive unit 62 of the present embodiment changes the posture of the adjustment door 61 so that the passage area of the air passage 520 changes periodically. Specifically, the drive unit 62 changes the posture of the adjustment door 61 to alternately repeat a state in which the passage area of the air passage 520 is larger than the opening area Sm of the outlet 522 and a state where the passage area of the air passage 520 is smaller than the opening area Sm of the outlet 522.

The drive unit 62 is made of an electric actuator such as a stepping motor. The drive unit 62 is controlled according to a control signal output from the door control unit 100.

The door control unit 100 includes a computer with a processor and a memory and its peripheral circuits. The door control unit 100 performs various calculations and processes based on the program stored in the memory, and controls the drive unit 62 connected to the output side. The memory of the door control unit 100 is composed of a non-transitory tangible storage medium.

The door control unit 100 is configured separately from an air conditioner ECU (not shown) that controls components of the indoor air conditioning unit 1. The door control unit 100 may be configured as a part of the air conditioner ECU.

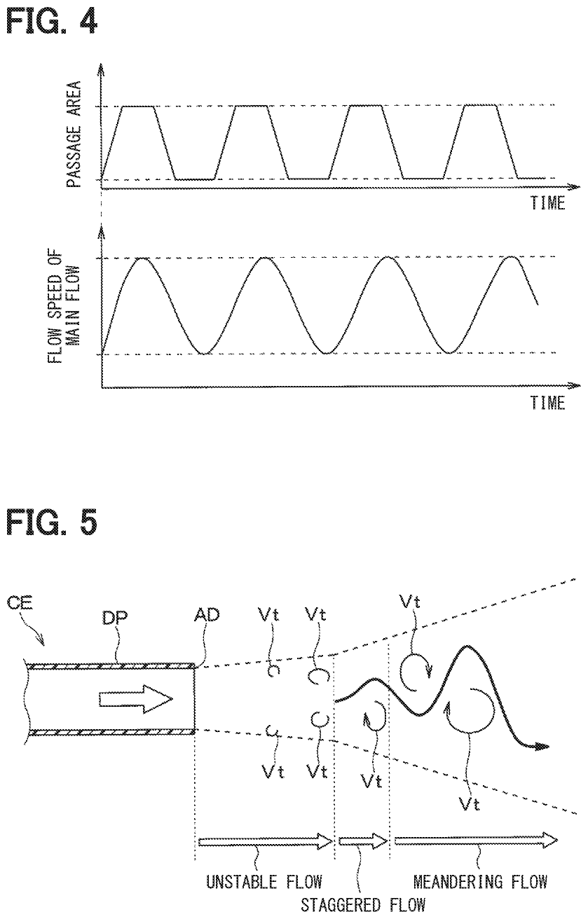

As shown in the upper part of FIG. 4, the door control unit 100 controls the drive unit 62 so that the passage area of the air passage 520 changes periodically. That is, the door control unit 100 controls the drive unit 62 so that the adjustment door 61 is periodically switched to the non-restricted posture and the restricted posture. The door control unit 100 controls the drive unit 62 so that the switching cycle for switching the posture of the adjustment door 61 is, for example, about 0.1 to 2 seconds.

As a result, the flow velocity (e.g., average flow velocity) of the main stream of the airflow blown out from the outlet 522 changes periodically as shown in the lower part of FIG. 4. The main stream is an air flow flowing in the opening direction orthogonal to the opening surface of the outlet 522.

As shown in FIG. 3, the duct portion 52 has the guiding structure 70 for making the flow velocity distribution of the air flow uniform on the downstream side of the adjustment door 61 of the passage variable device 60. The guiding structure 70 is provided downstream of the passage variable portion 53 in the duct portion 52.

The guiding structure 70 of the present embodiment is an enlarged portion 71 provided in the duct portion 52. The enlarged portion 71 is located downstream of the passage variable portion 53 where the passage area of the air passage 520 is larger than the opening area of the outlet 522.

The passage area of the enlarged portion 71 decreases from the upstream side to the downstream side in the air flow. That is, the passage area of the enlarged portion 71 continuously decreases as approaching the outlet 522. The enlarged portion 71 is set such that the ratio between the maximum passage area Sc and the opening area Sm of the outlet 522 is, for example, 7:2. The maximum passage area Sc in the enlarged portion 180 is an cross-sectional area of the duct portion at the upstream end in the air flow.

The duct portion 52 has the enlarged portion 71 provided downstream of the passage variable portion 53, so that the air flow that has passed through the passage variable portion 53 is contracted at the enlarged portion 71, and is rectified by the contracted flow.

Next, the operation of the air blowing device 50 will be described. When the blower 8 of the indoor air conditioning unit 1 starts to operate, temperature-controlled air is introduced from the indoor air conditioning unit 1 to the air blowing device 50. The air introduced into the air blowing device 50 is blown into the cabin from the outlet 522 via the duct portion 52.

FIG. 5 is an explanatory diagram for explaining the air flow blown out from an outlet AD of an air blowing device CE that is a comparative example of the air blowing device 50 of the present embodiment. The air blowing device CE of the comparative example is composed of a tubular duct portion DP having a constant passage cross section, and the airflow is blown out from the outlet AD as a steady flow. The steady flow is a flow with almost no change in flow velocity.

As shown in FIG. 5, when an air flow is blown out from an air blowing device CE of a comparative example, friction is generated between the air flow and stationary air (that is, stationary fluid), and an infinite number of lateral vortices Vt are generated around the main flow that is a core of the air flow. The lateral vortex Vt is a vortex whose axis is orthogonal to the main stream of the air flow.

Specifically, the lateral vortices Vt which are opposite to each other in the rotating direction are alternately generated downstream of the outlet AD, in a staggered manner. When such a staggered flow is generated around the main flow, a meandering flow is formed downstream of the outlet AD due to the interference between the main flow and the vortex. When a meandering flow is formed downstream of the outlet AD, the air flow is diffused, so that the distance from the outlet AD to the position where the air flow reaches is significantly shortened.

According to the air blowing device 50 of the present embodiment, the passage variable device 60 periodically changes the passage area of the air passage 520 so that the air flow becomes a pulsating flow and is blown out from the outlet 522.

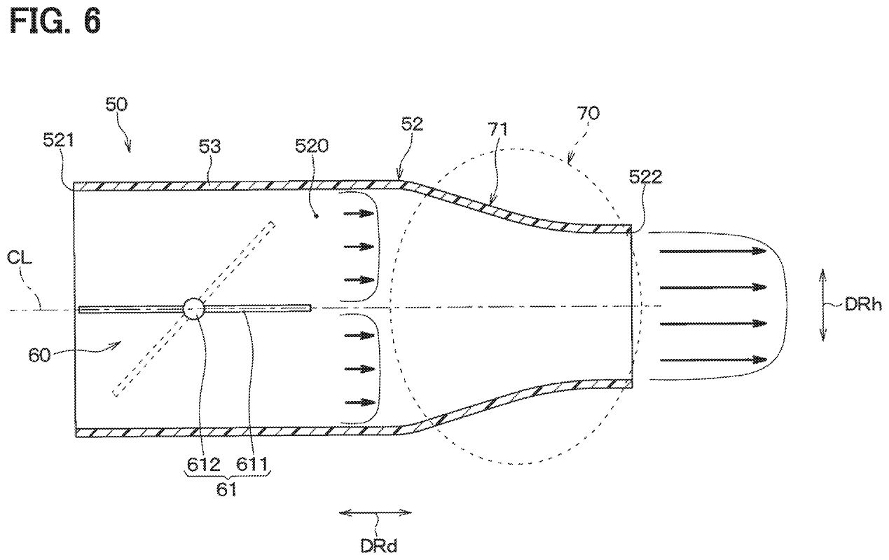

In the air blowing device 50, when the passage variable device 60 causes the passage area of the air passage 520 to be larger than that of the outlet 522, as shown in FIG. 6, the air flow is rectified at the enlarged portion 71, and is blown into the cabin from the outlet 522.

The air passage 520 is provided with the enlarged portion 71 having a passage area larger than the opening area Sm of the outlet 522. Therefore, a contracted flow occurs from the enlarged portion 71 to the outlet 522. Thus, in the air passage 520, the difference in flow velocity is reduced between the vicinity of the center of the outlet 522 and the vicinity of the inner surface of the air passage 520. As a result, the thickness of the velocity boundary layer formed downstream of the outlet 522 is reduced when the air flow is blown out from the outlet 522. That is, an air flow having a top hat velocity distribution is blown out from the outlet 522. The flow velocity of the air flow increases near the inner surface of the air passage 520 because a centrifugal force acts on the air flow along the wall surface due to the effect of the curvature of the inner surface forming the air passage 520. The contracted flow is a phenomenon in which the difference between the flow velocity near the wall surface of the passage and the flow velocity of the main flow is reduced by reducing the passage cross section.

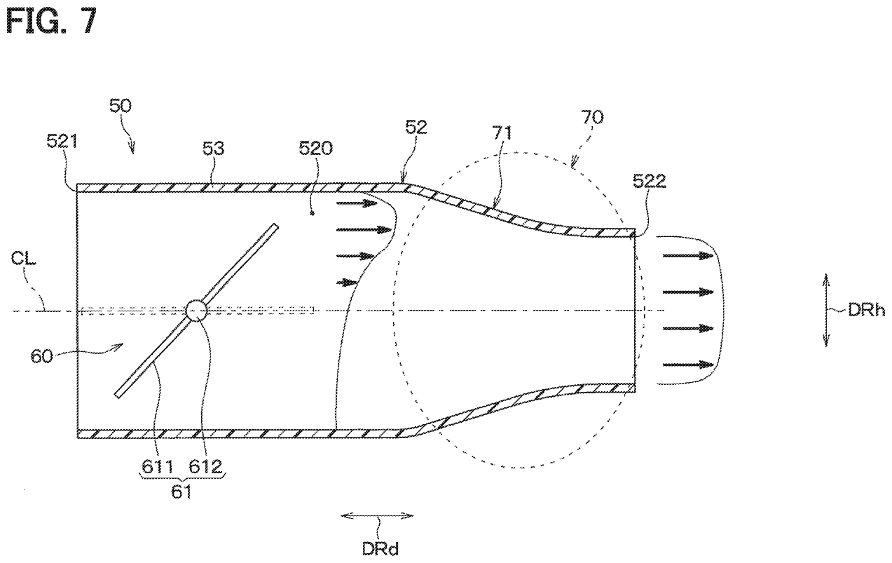

From this state, in the air blowing device 50, when the passage variable device 60 reduces the passage area of the air passage 520, as shown in FIG. 7, the passage area is reduced and the adjustment door 61 causes ventilation resistance. As a result, the flow velocity of the air flow passing through the inside of the passage variable portion 53 decreases.

Further, when the passage area of the air passage 520 is reduced by the passage variable device 60, the flow velocity distribution of the air flow is biased downstream of the passage variable portion 53 in the duct portion 52. Specifically, the flow velocity of the air flow downstream of the passage variable portion 53 decreases at a location near the plate surface of the adjustment door 61, and the flow velocity of the air flow increases at a location near the end of the adjustment door 61.

The enlarged portion 71 having a passage area larger than the opening area Sm of the outlet 522 is provided downstream of the passage variable portion 53, Therefore, a contracted flow occurs from the enlarged portion 71 to the outlet 522, and the difference in the flow velocity between the vicinity of the center of the outlet 522 and the vicinity of the inner surface of the air passage 520 becomes small. As a result, the thickness of the velocity boundary layer formed downstream of the outlet 522 is reduced when the air flow is blown out from the outlet 522. That is, an air flow having a top hat velocity distribution is blown out from the outlet 522.

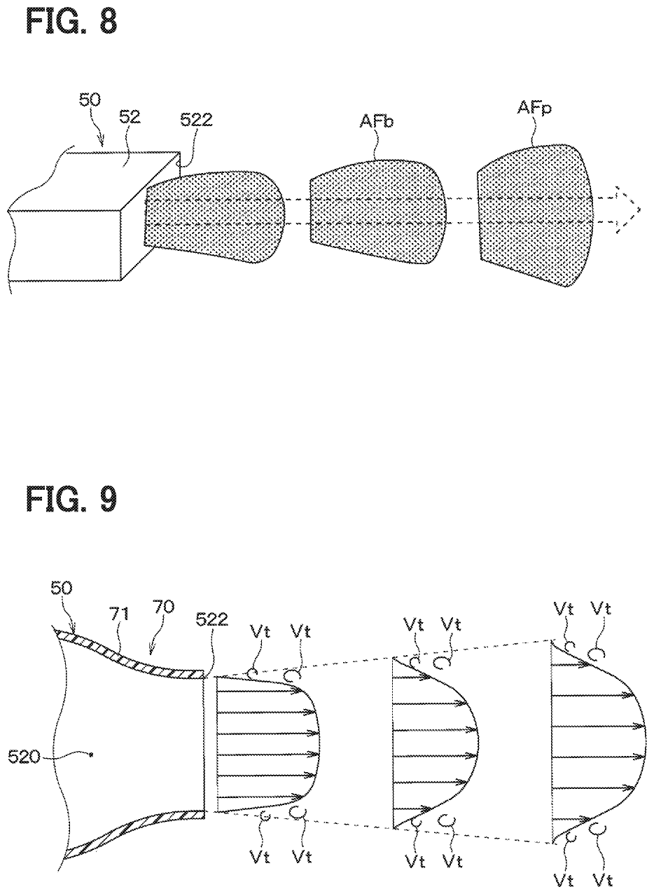

In the air blowing device 50 configured in this way, the air flow becomes a pulsating flow and is blown out from the outlet 522. At this time, as shown in FIG. 8, a preceding flow AFp and a back flow AFb are intermittently supplied downstream of the outlet 522.

Specifically, as shown in FIG. 9, when the air flow blown out from the outlet 522 becomes a pulsating flow, the position and the size of a lateral vortex Vt downstream of the outlet 522 change. In addition, the continuity of the lateral vortex Vt generated downstream of the outlet 522 is easily interrupted. This suppresses the development of the lateral vortex Vt and makes it difficult for a staggered vortex to be formed downstream of the outlet 522 so as to suppress a meandering flow from being formed downstream of the outlet 522.

The air blowing device 50 described above has the duct portion 52 with the outlet 522 to blow out the air flow at a downstream of the air passage 520, and the passage variable device 60 for changing the passage area of the air passage520 so that the air flow becomes a pulsating flow and is blown out from the outlet 522.

Accordingly, when the passage area of the air passage 520 is changed by the passage variable device 60, the air flow is blown out as a pulsating flow from the outlet 522. When the air flow blown out from the outlet 522 becomes a pulsating flow, the position, the size, etc. of the lateral vortex change at a downstream of the outlet 522. Therefore, it is difficult for staggered vortex rows to be formed downstream of the outlet 522, and a meandering flow is suppressed from being generated downstream of the outlet 522. Therefore, according to the air blowing device 50 of the present embodiment, it is possible to increase the distance from the outlet 522 to the position where the air flow blown out from the outlet 522 reaches.

The air blowing device 50 has the guiding structure 70 downstream of the passage variable portion 53 in the duct portion 52 for equalizing the flow velocity distribution of the air flow. Accordingly, the guiding structure 70 makes the flow velocity distribution uniform in the air passage 520 while the flow velocity distribution is affected by the passage variable device 60. For this reason, the air flow blown out from the outlet 522 is stabilized, so that the air flow blown out from the outlet 522 can flow to a far position.

Specifically, the guiding structure 70 includes the enlarged portion 71 provided in the duct portion 52. Since the air flow from the enlarged portion 71 toward the outlet 522 becomes a contracted flow, the flow velocity difference between the vicinity of the center of the main flow and the inner surface of the duct portion 52 becomes small, and it is possible to reduce the thickness of the velocity boundary layer formed near the inner surface of the duct portion 52. As a result, the attenuation of the flow velocity in the central portion of the air flow is suppressed, so that the air flow blown out from the outlet 522 can flow to a far position.

Further, the present embodiment in which the pulsating flow is generated by the air blowing device 50 is superior in responsiveness as compared with a case where the blower 8 is intermittently operated to generate the pulsating flow. That is, according to the air blowing device 50 of the present embodiment, it is possible to appropriately generate the pulsating flow, as compared with a device that intermittently operates the blower 8 to generate the pulsating flow.

### Second Embodiment

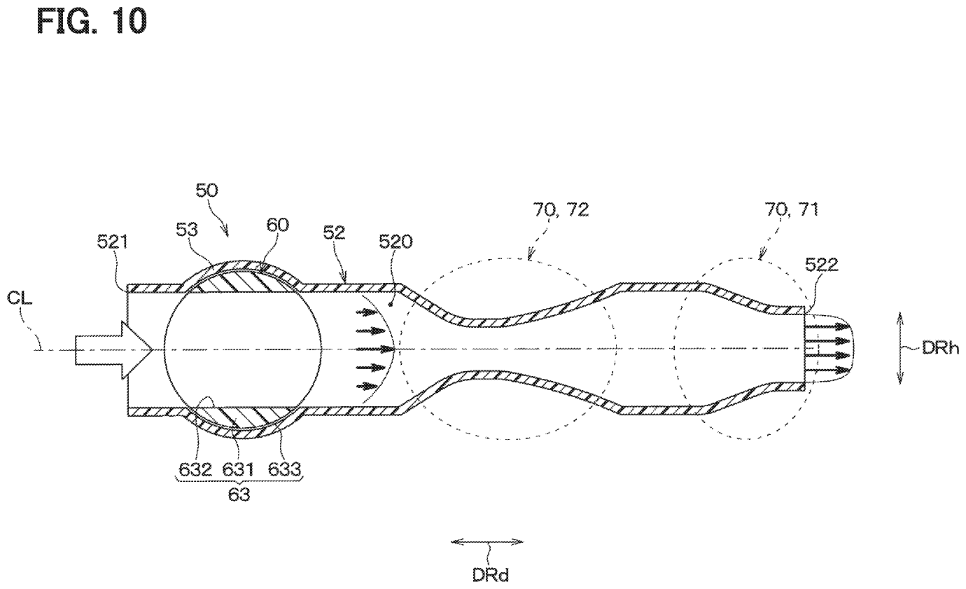

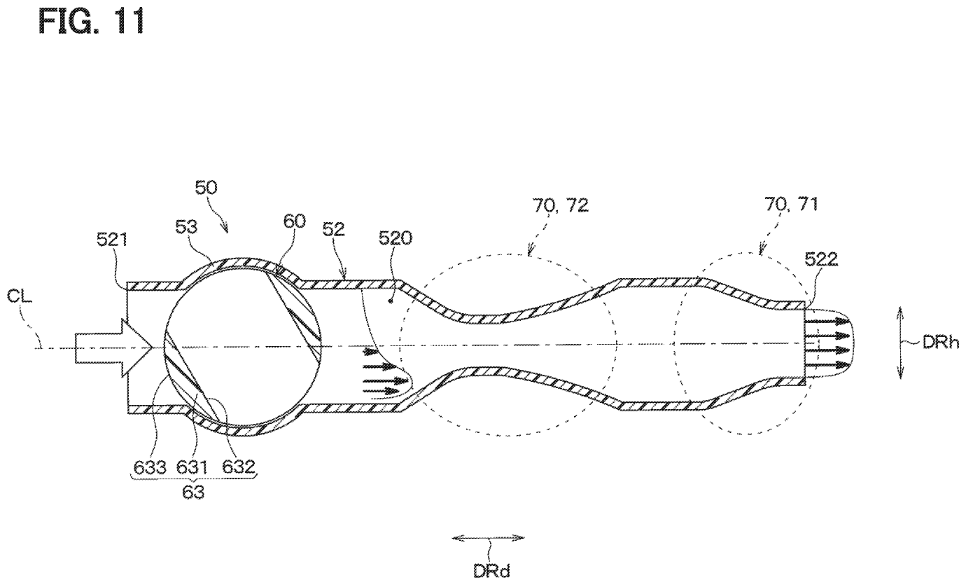

Next, a second embodiment will be described with reference to FIGS. 10 and 11. In this embodiment, parts different from the first embodiment will be mainly described.

As shown in FIGS. 10 and 11, the passage variable device 60 has an adjustment structure 63 instead of the adjustment door 61 of the first embodiment. The adjustment structure 63 has a substantially cylindrical columnar portion 631 and a shaft (not shown).

The columnar portion 631 is arranged so as to cross the air passage 520. That is, the columnar portion 631 is arranged so that its central axis intersects with the central axis CL of the air passage 520. The columnar portion 631 has a through hole 632 penetrating in a direction orthogonal to the central axis thereof. The through hole 632 has a size that allows the air flow flowing through the air passage 520 to pass through.

The adjustment structure 63 can be set to a first posture in which the axis of the through hole 632 extends in parallel to the extending direction of the air passage 520 and a second posture in which the axis of the through hole 632 intersects the extending direction of the air passage 520.

The air passage 520 has the maximum passage area, as shown in FIG. 10, when the adjustment structure 63 is in the first posture. Further, when the adjustment structure 63 is in the second posture, as shown in FIG. 11, the passage area of the air passage 520 is reduced since the air passage 520 is partially blocked by a side wall portion 633 of the adjustment structure 63. The first posture is a non-restricted posture in which the passage area of the air passage 520 is not limited by the adjustment structure 63. The second posture is a restricted posture in which the passage area of the air passage 520 is limited by the adjustment structure 63.

Although not shown, the drive unit 62 has the same configuration as that of the first embodiment, That is, the drive unit 62 is connected to the shaft of the adjustment structure 63 and changes the posture of the adjustment structure 63 so that the passage area of the air passage 520 changes periodically.

Although not shown, the door control unit 100 has the same configuration as that of the first embodiment. That is, the door control unit 100 controls the drive unit 62 so that the posture of the adjustment structure 63 is periodically switched to the non-restricted posture and the restricted posture,

In addition, the duct portion 52 has a narrowed portion 72 between the passage variable portion 53 and the enlarged portion 71, The narrowed portion 72 narrows the passage area of the air passage 520 between the passage variable portion 53 and the enlarged portion 71 to be equal to the opening area of the outlet 522.

Since the duct portion 52 has the narrowed portion 72 downstream of the passage variable portion 53, the air flow that has passed through the passage variable portion 53 is contracted at the narrowed portion 72, and is rectified by the contracted flow. Further, since the enlarged portion 71 is provided downstream of the narrowed portion 72, the air flow passing through the narrowed portion 72 is contracted at the enlarged portion 71 and is rectified by the contracted flow. In the present embodiment, the enlarged portion 71 and the narrowed portion 72 form the guiding structure 70.

The other configurations are the same as those of the first embodiment. The air blowing device 50 of this embodiment has the same configuration as that of the first embodiment, Therefore, it is possible to obtain the same operational effect as the first embodiment, which is achieved by the same configuration as that of the first embodiment.

In the air blowing device 50 of the present embodiment, the guiding structure 70 is composed of the narrowed portion 72 and the enlarged portion 71 provided in the duct portion 52. Accordingly, the air flow that has passed through the passage variable portion 53 is rectified by the narrowed portion 72 and the enlarged portion 71. For this reason, the attenuation of the flow velocity in the central portion of the air flow is suppressed, so that the distance from the outlet 522 to the position where the air flow blown out from the outlet 522 reaches can be increased.

### Modification of the Second Embodiment

In the second embodiment, the air blowing device 50 is provided by a combination of the passage variable device 60 including the adjustment structure 63 and the guiding structure 70 including the narrowed portion 72 and the enlarged portion 71, but is not limited to this. In the air blowing device 50, for example, one of the passage variable device 60 and the guiding structure 70 may be configured by one other than the second embodiment.

### Third Embodiment

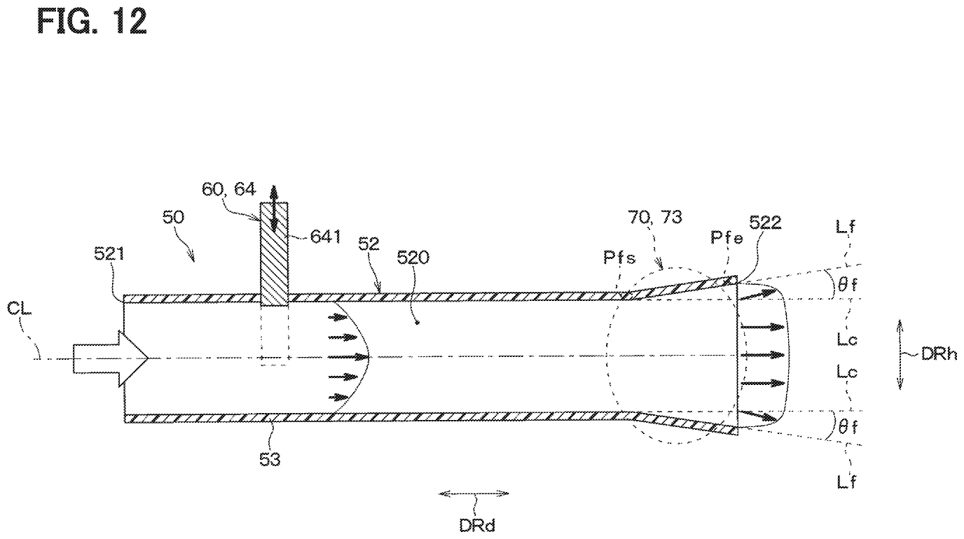

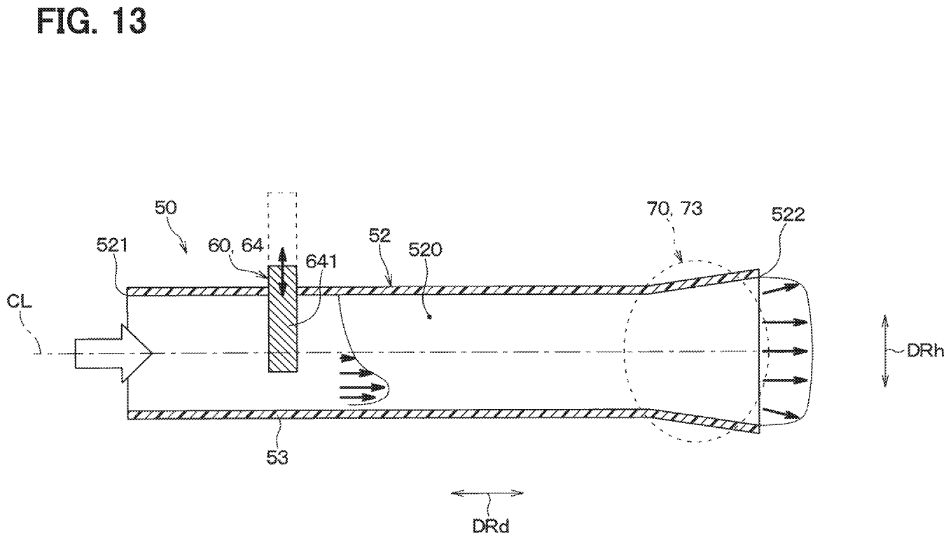

Next, a third embodiment will be described with reference to FIGS. 12 and 13, In this embodiment, parts different from the first embodiment will be mainly described. As shown in FIGS. 12 and 13, the passage variable device 60 has a single-side-opening slide door 64 instead of the adjustment door 61 of the first embodiment. The slide door 64 has a single door portion 641 and a linear motion conversion device (not shown).

The door portion 641 is formed in a plate shape, and is arranged so that its plate surface can be displaced in a direction intersecting the central axis CL of the air passage 520. The linear motion conversion device converts the rotational motion output from the drive unit 62 into the linear motion of the door portion 641. The linear motion conversion device may include, for example, a rack and pinion.

The slide door 64 can be set in a first posture in which most of the door portion 641 is located outside the air passage 520 and a second posture in which most of the door portion 641 is located inside the air passage 520.

The air passage 520 has the maximum passage area as shown in FIG. 12 when the slide door 64 is in the first posture. Further, when the slide door 64 is in the second posture, the air passage 520 is partially blocked by the slide door 64 as shown in FIG. 13, such that the passage area is reduced, The first posture is a non-restricted posture in which the passage area of the air passage 520 is not limited by the slide door 64. The second posture is a restricted posture in which the passage area of the air passage 520 is limited by the slide door 64.

Although not shown, the drive unit 62 has the same configuration as that of the first embodiment, That is, the drive unit 62 is connected to the linear motion conversion device of the slide door 64, and changes the posture of the slide door 64 so that the passage area of the air passage 520 changes periodically.

Although not shown, the door control unit 100 has the same configuration as that of the first embodiment. That is, the door control unit 100 controls the drive unit 62 so that the posture of the slide door 64 periodically switches between the non-restricted posture and the restricted posture.

In addition, the duct portion 52 has the flare portion 73 located downstream of the passage variable portion 53 to be continuous with the outlet 522, in which the inner surface of the air passage 520 is separated from the central axis CL of the air passage 520 as approaching the outlet 522. The flare portion 73 is enlarged in a trumpet shape toward the outlet 522.

If the flare portion 73 and its vicinity are extremely widened, the air flow may be separated from the wall surface and the turbulence may increase. Therefore, in the flare portion 73, the angle Of formed between the virtual line Lc parallel to the central axis CL of the air passage 520 and the virtual line Lf connecting the start point Pfs and the end point Pfe of the flare portion 73 is set as, for example, 7 degrees or less.

In the duct portion 52, the air flow flowing in the air passage 520 is blown out from the outlet 522. At this time, since the flare portion 73 is provided to be connected to the outlet 522, the velocity boundary layer of the air flow is separated from the central axis CL of the air passage 520 at a downstream of the outlet 522. As a result, the attenuation of the flow velocity is reduced in the central portion of the air flow, and the distance from the outlet 522 to the position where the airflow blown out from the outlet 522 reaches can be increased. In the present embodiment, the flare portion 73 constitutes the guiding structure 70.

The other configurations are the same as those of the first embodiment. The air blowing device 50 of this embodiment has the same configuration as that of the first embodiment. Therefore, it is possible to obtain the same operational effect as the first embodiment, which is achieved by the same configuration as that of the first embodiment.

In the air blowing device 50 of the present embodiment, the guiding structure 70 is composed of the flare portion 73. Accordingly, the air flow passing through the passage variable portion 53 is rectified by the flare portion 73. For this reason, the attenuation of the flow velocity is suppressed in the central portion of the air flow, so that the distance from the outlet 522 to the position where the air flow blown out from the outlet 522 reaches can be increased.

### Modification of the Third Embodiment

In the third embodiment, the air blowing device 50 is defined by a combination of the passage variable device 60 including the slide door 64 and the guiding structure 70 including the flare portion 73, but the air blowing device 50 is not limited to this. In the air blowing device 50, for example, one of the passage variable device 60 and the guiding structure 70 may be configured by one other than the third embodiment.

### Fourth Embodiment

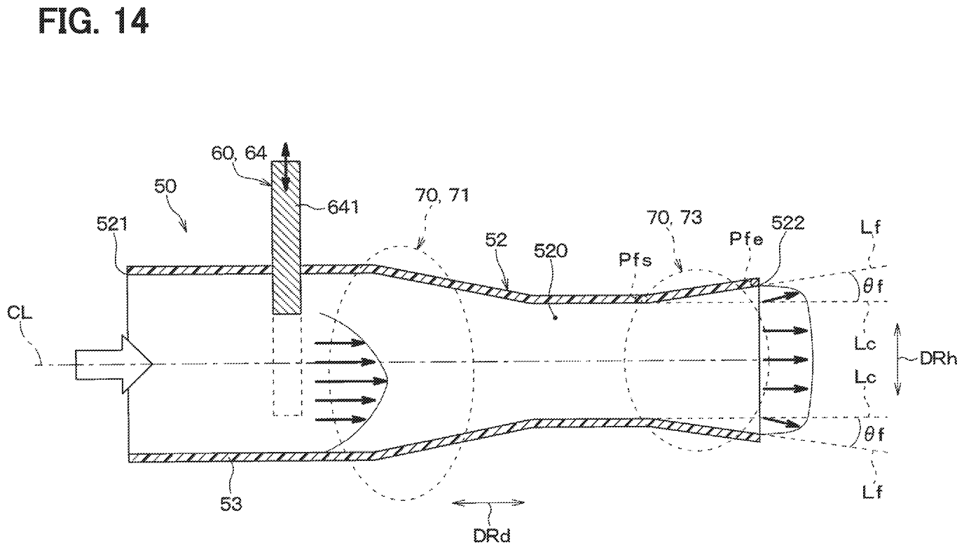

Next, a fourth embodiment will be described with reference to FIG. 14. In this embodiment, parts different from the third embodiment will be mainly described.

As shown in FIG. 14, the duct portion 52 has the enlarged portion 71 between the passage variable portion 53 and the flare portion 73. As in the first embodiment, the passage area of the air passage 520 is larger at the enlarged portion 71 downstream of the passage variable portion 53 than the opening area of the outlet 522.

In the duct portion 52 configured in this way, since the enlarged portion 71 is provided downstream of the passage variable portion 53, the air flow passing through the passage variable portion 53 is contracted at the enlarged portion 71, and is rectified by the contracted flow. Further, since the flare portion 73 is provided downstream of the enlarged portion 71, the velocity boundary layer of the air flow is separated from the central axis CL of the air passage 520 at the downstream of the outlet 522. In this embodiment, the enlarged portion 71 and the flare portion 73 form the guiding structure 70.

The other configurations are the same as those of the third embodiment. The air blowing device 50 of this embodiment has the same configuration as that of the third embodiment. For this reason, it is possible to obtain the same operational effect as the third embodiment, which is achieved by the same configuration as that of the third embodiment.

In the air blowing device 50 of the present embodiment, the guiding structure 70 is composed of the enlarged portion 71 and the flare portion 73 provided in the duct portion 52. Accordingly, the air flow that has passed through the passage variable portion 53 is rectified by the enlarged portion 71 and the flare portion 73. For this reason, the attenuation of the flow velocity is suppressed in the central portion of the air flow, so that the air flow blown out from the outlet 522 can arrive at a far position.

### Fifth Embodiment

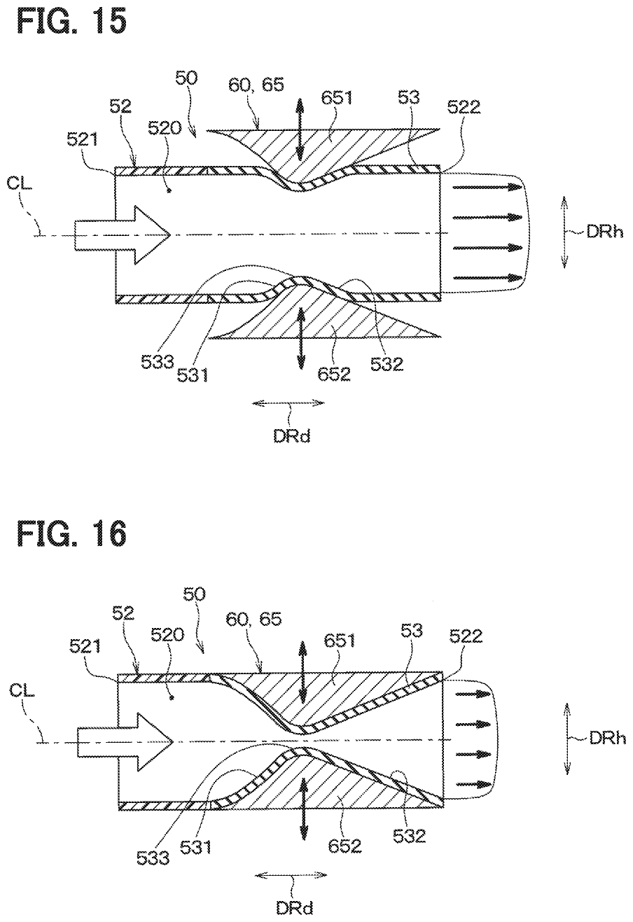

Next, a fifth embodiment will be described with reference to FIGS. 15 to 17. In this embodiment, parts different from the first embodiment will be mainly described.

As shown in FIGS. 15 and 16, the duct portion 52 has the passage variable portion 53 in which the passage area is changed by the passage variable device 60, and the passage variable portion 53 is set within a range from the outlet 522 to the front of the inlet 521. The passage variable portion 53 is configured to be deformed when an external force is applied. That is, the passage variable portion 53 is made of a material having elasticity (for example, rubber material).

The passage variable device 60 is configured to change the passage area of the air passage 520 by deforming the passage variable portion 53. The passage variable device 60 of the present embodiment is configured to deform the passage variable portion 53 such that at least a part of the inner surface of the passage variable portion 53 approaches the center of the air passage 520. Specifically, the passage variable device 60 has a deformation member 65 that deforms the passage variable portion 53.

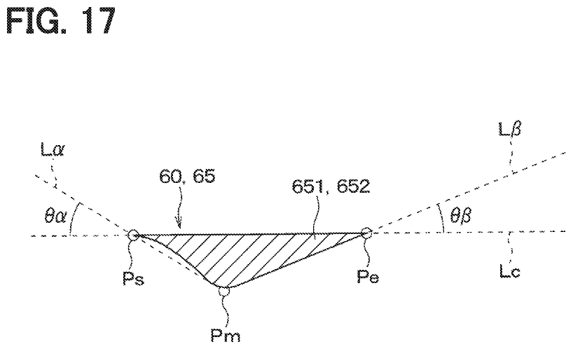

The deformation member 65 has pressing portions 651 and 652 for applying an external force to the passage variable portion 53, and a linear motion conversion device (not shown). As shown in FIG. 17, the pressing portion 651, 652 is a substantially triangular member having an obtuse angle. The pressing portions 651 and 652 are arranged such that the apex portions Pm having the obtuse angle face each other with the passage variable portion 53 interposed therebetween.

The pressing portion 651, 652 is formed such that the angle θα at the upstream corner Ps located on the upstream side is 20 degrees or less, and the angle θβ at the downstream corner Pe located on the downstream side is 3.5 degrees or less. The angle θα is formed by the central axis CL of the air passage 520 and an imaginary line Lα connecting the upstream corner Ps and the apex portion Pm. Further, the angle θβ is formed by the central axis CL of the air passage 520 and an imaginary line Lα connecting the apex portion Pm and the downstream corner Pe.

The pressing portions 651 and 652 of this embodiment are formed such that the angle θα of the upstream corner Ps is larger than the angle θβ of the downstream corner Pe. In the pressing portion 651, 652, for example, the angle θα of the upstream corner Ps and the angle θβ of the downstream corner Pe may be approximately the same size.

The linear motion conversion device converts the rotational motion output from the drive unit 62 into the linear motion of the pressing portions 651 and 652. The linear motion conversion device may include, for example, a rack and pinion.

The deformation member 65 can be set to a first posture in which the apex portion Pm of the pressing portion 651, 652 is separated from the central axis CL of the air passage 520, and a second posture in which the apex portion Pm of the pressing portion 651, 652 approaches the central axis CL of the air passage 520.

When the deformation member 65 is in the first posture, the air passage 520 has the maximum passage area as shown in FIG. 15. When the deformation member 65 is in the second posture, as shown in FIG. 16, the apex portion Pm of the pressing portion 651, 652 approaches the central axis CL of the air passage 520 such that the passage area of the air passage 520 is reduced. The first posture is a non-restricted posture in which the passage area of the air passage 520 is not limited by the deformation member 65. Further, the second posture is a restricted posture in which the passage area of the air passage 520 is limited by the deformation member 65.

As shown in FIG. 16, the passage variable portion 53 has the contracted slope portion 531 where the passage area of the air passage 520 is continuously reduced and the enlarged slope portion 532 where the passage area of the air passage 520 is continuously increased, when the passage area of the air passage 520 is reduced. Further, the passage variable portion 53 has a throat passage 533 between the contracted slope portion 531 and the enlarged slope portion 532 in which the passage area of the air passage 520 is minimized. The enlarged slope portion 532 is formed downstream of the contracted slope portion 531 and the throat passage 533 in the duct portion 52, to be continuous with the outlet 522.

As described above, the passage variable device 60 of the present embodiment is configured such that the passage area of the air passage 520 is variable so as to form the throat passage 533 between the contracted slope portion 531 and the enlarged slope portion 532, to reduce the passage area of the air passage 520.

The drive unit 62 has the same configuration as that of the first embodiment. That is, the drive unit 62 is connected to the linear motion conversion device of the deformation member 65, and changes the posture of the deformation member 65 so that the passage area of the air passage 520 changes periodically.

Although not shown, the door control unit 100 has the same configuration as that of the first embodiment. That is, the door control unit 100 controls the drive unit 62 so that the posture of the deformation member 65 periodically switches between the non-restricted posture and the restricted posture.

Next, the operation of the air blowing device 50 will be described. When the blower 8 of the indoor air conditioning unit 1 starts to operate, temperature-controlled air is introduced from the indoor air conditioning unit 1 to the air blowing device 50. The air introduced into the air blowing device 50 is blown into the cabin from the outlet 522 via the duct portion 52. Since the passage area of the air passage 520 is periodically changed by the air blowing device 50, the air flow is blown out as a pulsating flow from the outlet 522.

When the passage area of the air passage 520 is reduced by the passage variable device 60, the duct portion 52 has the contracted slope portion 531, the throat passage 533, and the enlarged slope portion 532. According to this, when changing the passage area of the air passage 520 by the passage variable device 60, the air flow from the contracted slope portion 531 toward the throat passage 533 becomes a contracted flow. Therefore, the difference in the flow velocity between the vicinity of the central axis of the main flow and the vicinity of the inner surface of the duct portion 52 becomes small, and the thickness of the velocity boundary layer formed near the inner surface of the duct portion 52 can be reduced.

In addition, when the passage variable device 60 changes the passage area of the air passage 520, the enlarged slope portion 532 is formed to be continuous with the outlet 522. According to this, the velocity boundary layer of the air flow downstream of the outlet 522 is easily formed away from the vicinity of the center of the outlet 522 depending on the shape of the inner wall surface continuous with the outlet 522. As a result, the attenuation of the flow velocity in the central portion of the air flow is suppressed, so that the distance from the outlet 522 to the position where the air flow blown out from the outlet 522 reaches can be increased.

The other configurations are the same as those of the first embodiment. The air blowing device 50 of this embodiment has the same configuration as that of the third embodiment. For this reason, it is possible to obtain the same operational effect as the third embodiment, which is achieved by the same configuration as that of the third embodiment.

In the air blowing device 50 of the present embodiment, when the passage variable device 60 reduces the passage area of the air passage 520, the airflow flowing through the air passage 520 is rectified by the contracted slope portion 531, the throat passage 533 and the enlarged slope portion 532. According to this, the air flow flowing through the air passage 520 can be rectified without providing a dedicated guiding structure for the duct portion 52.

In addition, in the air blowing device 50 of the present embodiment, the passage variable device 60 is configured to deform the passage variable portion 53 so that at least a part of the inner surface of the passage variable portion 53 approaches the central axis CL of the air passage 520. According to this, the flow velocity distribution of the air flow is less likely to be biased at the downstream of the passage variable portion 53. As a result, the air flow blown out from the outlet 522 is stabilized, and can reach a far position.

### Modification of the Fifth Embodiment

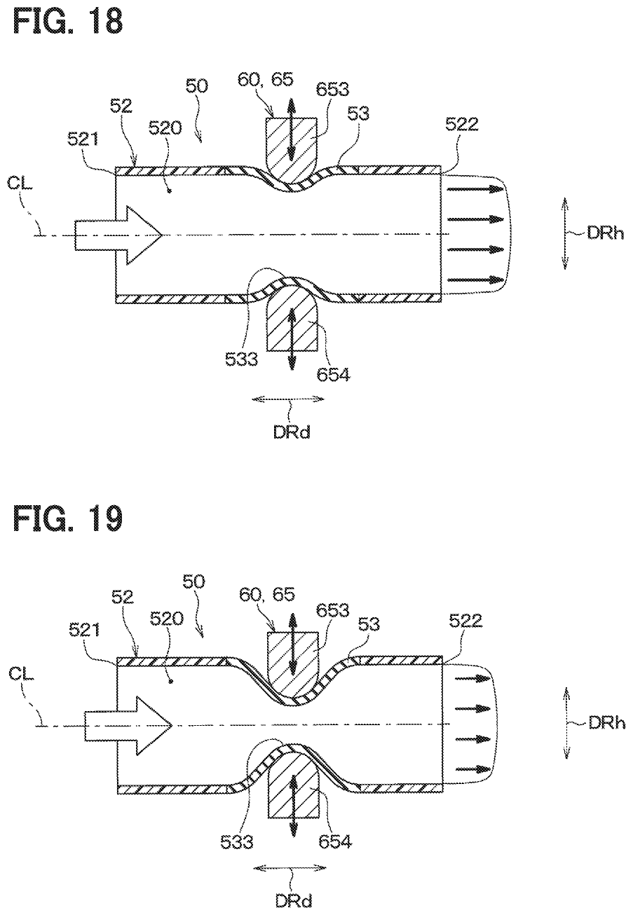

In the fifth embodiment, the passage variable portion 53 is set from the outlet 522 to the front of the inlet 521, and the passage variable portion 53 is pressed by the pressing portions 651, 652 having a substantially triangular shape, but is not limited to this. In the air blowing device 50, for example, as shown in FIGS. 18 and 19, the passage variable portion 53 is set in an area between the outlet 522 and the inlet 521, and the passage variable portion 53 may be configured to be pressed by the pressing portions 653 and 654 having an arc surface at the tip.

### Sixth Embodiment

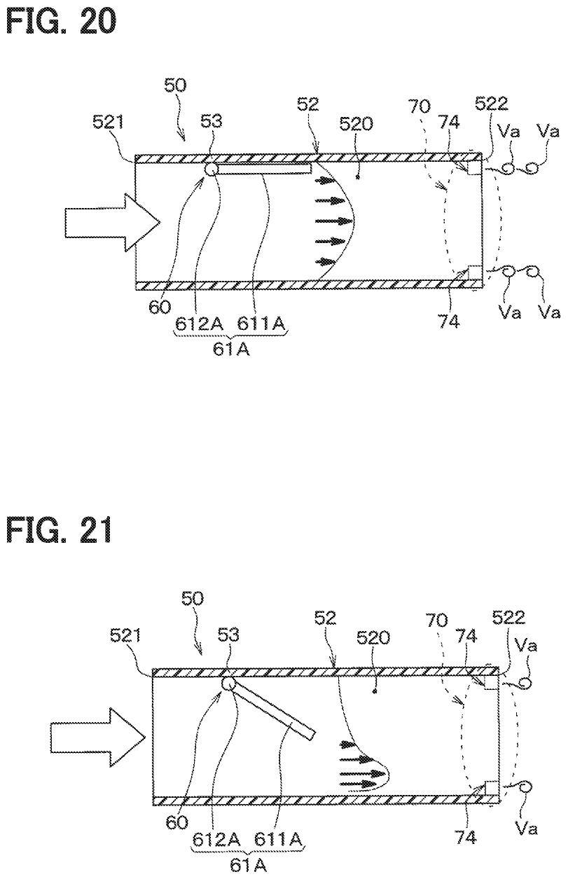

Next, a sixth embodiment will be described with reference to FIGS. 20 to 22. In this embodiment, parts different from the first embodiment will be mainly described.

As shown in FIGS. 20 and 21, the passage variable device 60 includes an adjustment door 61A for adjusting the passage area of the air passage 520. The adjustment door 61A is configured by a cantilever rotary door having a door portion 611A formed in a plate shape and a door shaft 612A connected to one end of the door portion 611A. The adjustment door 61A has a first posture in which the plate surface of the door portion 611A extends parallel to the air passage 520 and a second posture in which the plate surface of the door portion 611A intersects the extending direction of the air passage 520.

The air passage 520 has the largest passage area as shown in FIG. 12 when the adjustment door 61A is in the first posture. When the adjustment door 61A is in the second posture, the air passage 520 is partially closed by the adjustment door 61A as shown in FIG. 21 such that the passage area is reduced. Although not shown, the drive unit 62 and the door control unit 100 are configured similarly to the first embodiment.

A vortex generator 74 is arranged in the duct portion 52 to be continuous with the outlet 522, downstream of the passage variable portion 53. The vortex generator 74 is configured to generate an auxiliary vortex Va that has different vortex characteristics such as rotation direction and axis direction of the vortex from a lateral vortex generated downstream of the outlet 522.

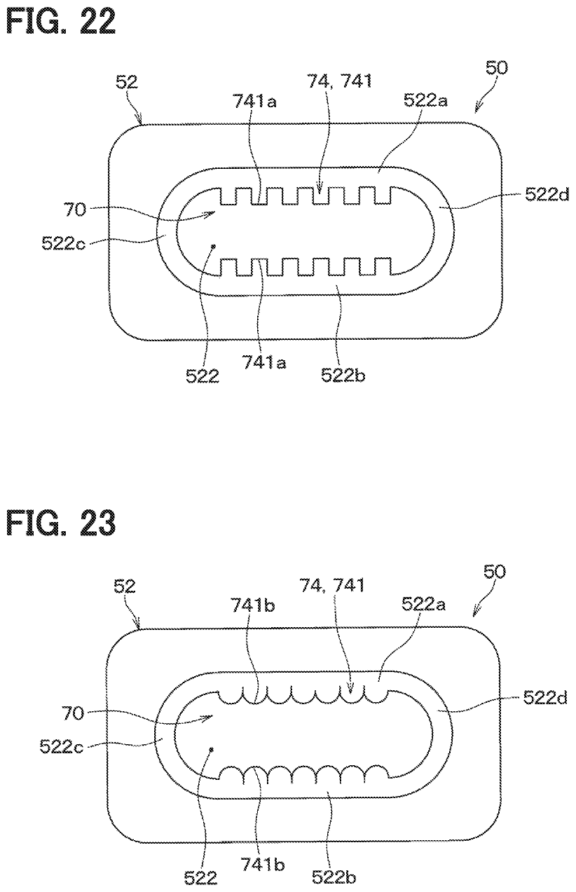

As shown in FIG. 22, the vortex generator 74 has a serration portion 741 provided in the duct portion to be continuous with the outlet 522. The serration portion 741 is provided at a part of the inner side of the duct portion to be continuous with the outlet 522. The serration portion 741 may be provided around the entire circumference inside the duct portion to be continuous with the outlet 522.

Specifically, the serration portion 741 has plural square-shaped convex portions 741a arranged at predetermined intervals inside the duct portion to be continuous with the outlet 522. The convex portions 741a protrude toward the air passage 520 from the portion connected to the outlet 522. Specifically, the convex portions 741a are projected in a direction intersecting the opening direction of the outlet 522. The opening direction of the outlet 522 is orthogonal to the opening surface of the outlet 522.

Since the vortex generator 74 is provided in the duct portion 52 to be continuous with the outlet 522, when the air flow passes around the vortex generator 74, an auxiliary vortex Va is generated. The auxiliary vortex is different from the lateral vortex in at least one of the rotation direction and the axis direction of the vortex.

In such a structure, the auxiliary vortex Va rectifies the air flow inside the outlet 522, so that the velocity boundary layer formed inside the outlet 522 can be made thin. That is, an air flow having a top hat velocity distribution is blown out from the outlet 522. In the present embodiment, the vortex generator 74 constitutes the guiding structure 70.

The other configurations are the same as those of the first embodiment. The air blowing device 50 of this embodiment has the same configuration as that of the first embodiment. Therefore, it is possible to obtain the same operational effect as the first embodiment, which is achieved by the same configuration as that of the first embodiment.

In this embodiment, since the vortex generator 74 is provided as the guiding structure 70, the air flow having the top hat velocity distribution is blown out from the outlet 522. According to this, since the attenuation of the flow velocity is suppressed in the central portion of the air flow blown out from the outlet 522, it is possible for the air flow blown out from the outlet 522 to reach a far position.

In addition, the auxiliary vortex Va collides with the lateral vortex Vt downstream of the outlet 522, whereby the lateral vortex Vt can be disturbed. Then, the auxiliary vortex Va collides with the lateral vortex Vt to suppress the development of the lateral vortex Vt. Therefore, it is difficult for a staggered vortex to be formed downstream of the outlet 522, and the meandering flow of the air flow is suppressed at the downstream of the outlet 522.

### First Modification of the Sixth Embodiment

In the sixth embodiment, the serration portion 741 has the plural square-shaped convex portions 741a, but is not limited to this. The serration portion 741 may have, for example, plural arc-shaped convex portions 741b as shown in FIG. 23.

### Second Modification of the Sixth Embodiment

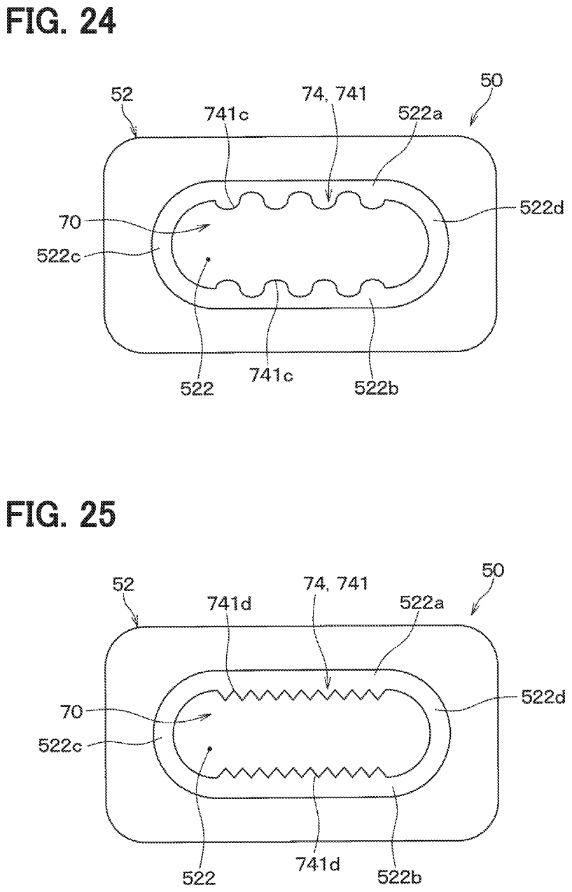

The serration portion 741 may include, for example, as shown in FIG. 24, a convex-concave portion 741c in which arc-shaped convex portions and concave portions are alternately arranged. In addition, for example, the convex-concave portion 741c may have polygonal convex portions and concave portions arranged alternately.

### Third Modification of the Sixth Embodiment

The serration portion 741 may have plural triangular protrusions 741d as shown in FIG. 25. In other words, the serration portion 741 may be formed in a sawtooth shape.

### Other Modification of the Sixth Embodiment

In the sixth embodiment, the air blowing device 50 is defined by a combination of the passage variable device 60 including the adjustment door 61A and the guiding structure 70 including the vortex generator 74, but the air blowing device 50 is not limited to this. In the air blowing device 50, for example, one of the passage variable device 60 and the guiding structure 70 may be configured by one other than the sixth embodiment. This also applies to the seventh embodiment.

### Seventh Embodiment

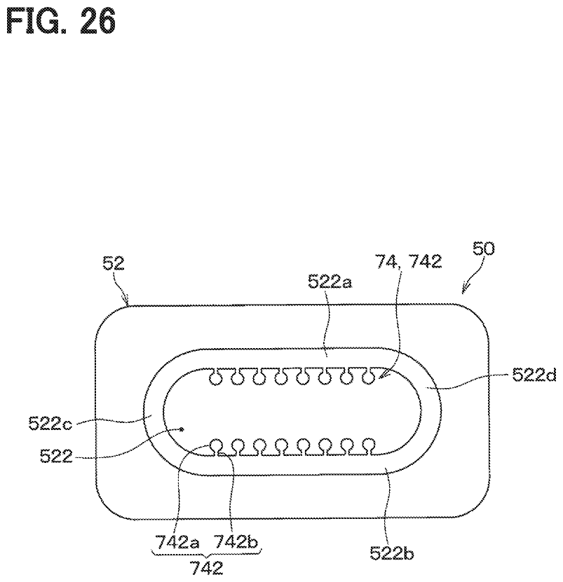

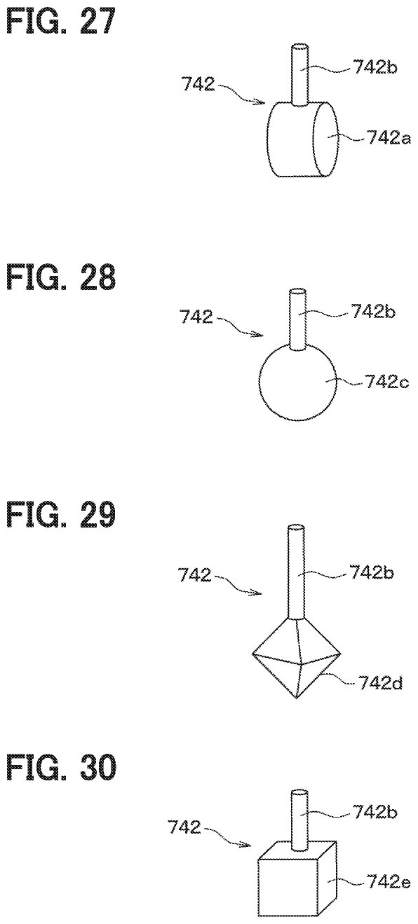

Next, a seventh embodiment will be described with reference to FIGS. 26 and 27. In the present embodiment, parts different from the sixth embodiment will be mainly described,

As shown in FIG. 26, the vortex generator 74 includes plural block bodies 742 arranged with a predetermined gap inside the duct portion to be continuous with the outlet 522. The block bodies 742 are provided in a part of the duct portion to be continuous with the outlet 522. It should be noted that the block bodies 742 may be provided around the entire inner circumference to be continuous with the outlet 522.

The block bodies 742 project toward the air passage 520 from the portion connected to the outlet 522, Specifically, the block bodies 742 project in a direction intersecting with the opening direction of the outlet 522.

As shown in FIG. 27, the block body 742 has a main body 742a facing the center of the air passage 520 and a rod-shaped support portion 742b that supports the main body 742a. Specifically, the main body 742a has a circular shape when viewed from the opening direction of the outlet 522 and a quadrangular shape when viewed from a direction orthogonal to the opening direction of the outlet 522. The support portion 742b is fixed to the portion connected to the outlet 522.

The other configurations are the same as those of the sixth embodiment. The air blowing device 50 of the present embodiment can obtain the same operational effect as the sixth embodiment by the same configuration as that of the sixth embodiment,

### First Modification of the Seventh Embodiment

In the seventh embodiment, the block body 742 having the disk-shaped main body 742a is illustrated, but the block body 742 is not limited to this. The block body 742 may have a spherical main body 742c as shown in FIG. 28.

### Second Modification of the Seventh Embodiment

The block body 742 may have an octahedral main body 742d as shown in FIG. 29. According to this, the number of edges formed in the main body 742d increases, and thus the auxiliary vortex Va having various vortex axes is easily generated.

### Third Modification of the Seventh Embodiment

The block body 742 may have a hexahedral main body 742e as shown in FIG. 30. This also increases the number of edges formed on the main body 742e, which facilitates the generation of auxiliary vortices Va having various vortex axes,

### Eighth Embodiment

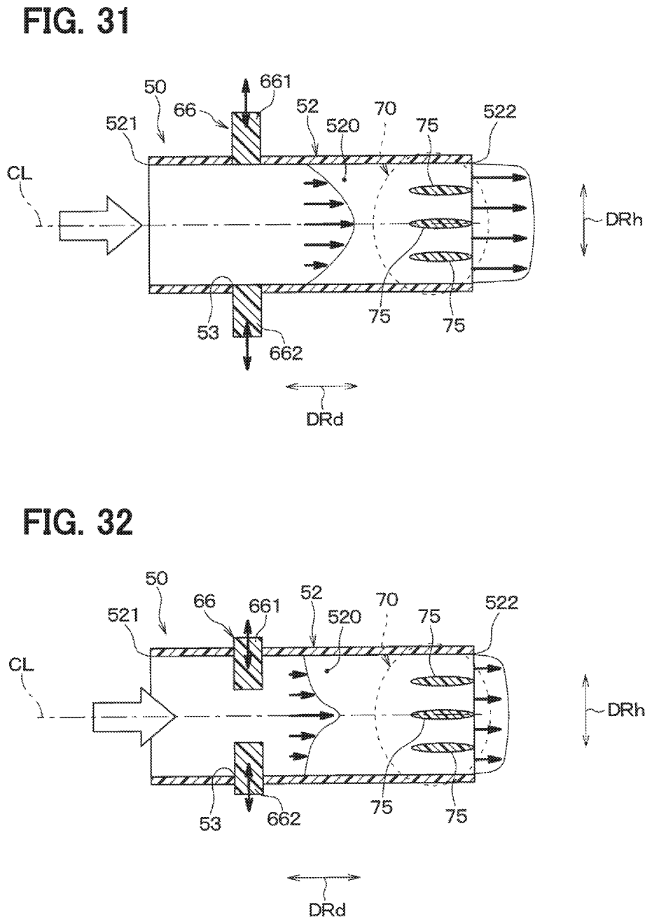

Next, an eighth embodiment will be described with reference to FIGS. 31 and 32. In this embodiment, parts different from the first embodiment will be mainly described.

As shown in FIGS. 31 and 32, the passage variable device 60 has a double door 66 that is a slide door open on the both sides. The double door 66 of this embodiment has door portions 661 and 662 and a linear motion conversion device (not shown).

The door portions 661 and 662 are arranged so as to face each other with the air passage 520 interposed therebetween. Specifically, the door portions 661 and 662 are formed in a plate shape, and are arranged so that their plate surfaces can be displaced in a direction intersecting the central axis CL of the air passage 520.

The linear motion conversion device converts the rotational movement output from the drive unit 62 into the linear movement of the door portions 661 and 662. The linear motion conversion device includes, for example, a rack and pinion.

The double door 66 can be set to a first posture in which the door portions 661 and 662 are separated from the central axis CL of the air passage 520, and a second posture in which the door portions 661 and 662 are close to the central axis CL of the air passage 520.

The air passage 520 has the maximum passage area as shown in FIG. 31 when the double door 66 is in the first posture. When the double door 66 is in the second posture, as shown in FIG. 32, the air passage 520 is partially blocked by the plate surface of the double door 66, so that the passage area is reduced. The first posture is an non-restricted posture in which the passage area of the air passage 520 is not limited by the double door 66, The second posture is a restricted posture in which the passage area of the air passage 520 is limited by the double door 66.

Although not shown, the drive unit 62 has the same configuration as that of the first embodiment. That is, the drive unit 62 is connected to the linear motion conversion device of the double door 66, and changes the posture of the double door 66 so that the passage area of the air passage 520 changes periodically.

Although not shown, the door control unit 100 has the same configuration as that of the first embodiment. That is, the door control unit 100 controls the drive unit 62 so that the posture of the double door 66 is periodically switched to the non-restricted posture and the restricted posture.

In addition, plural fins 75 that cross the air passage 520 are arranged downstream of the passage variable portion 53 in the duct portion 52. Each of the fins 75 is formed in a plate shape and the fins 75 are arranged in the air passage 520 so that their surfaces are parallel to each other.

In the duct portion 52 configured in this manner, the air flow flowing into the air passage 520 is rectified by the fins 75 and then blown out from the outlet 522. As a result, the attenuation of the flow velocity is reduced in the central portion of the air flow, and the distance to the position where the air flow reaches from the outlet 522 can be increased. In the present embodiment, the fins 75 form the guiding structure 70.

The other configurations are the same as those of the first embodiment. The air blowing device 50 of this embodiment has the same configuration as that of the first embodiment. Therefore, it is possible to obtain the same operational effect as the first embodiment, which is achieved by the same configuration as that of the first embodiment.

In the air blowing device 50 of the present embodiment, the guiding structure 70 is composed of the fins 75. According to this, the air flow passing through the passage variable portion 53 is rectified by the fins 75. For this reason, the attenuation of the flow velocity in the central portion of the air flow is suppressed, so that the distance to the position where the air flow reaches from the outlet 522 can be increased.

### Modification of the Eighth Embodiment

In the eighth embodiment, the guiding structure 70 includes the fins 75, but is not limited to this. The guiding structure 70 may have a single fin 75. In addition, the guiding structure 70 may have plural fins 75 arranged in a grid or a movable fin 75 that changes the flowing direction of the air flow blown out from the outlet 522.

In the eighth embodiment, the air blowing device 50 has the passage variable device 60 including the double door 66 and the guiding structure 70 including the fins 75, but is not limited to this. In the air blowing device 50, for example, one of the passage variable device 60 and the guiding structure 70 may be configured by one other than the eighth embodiment.

### Ninth Embodiment

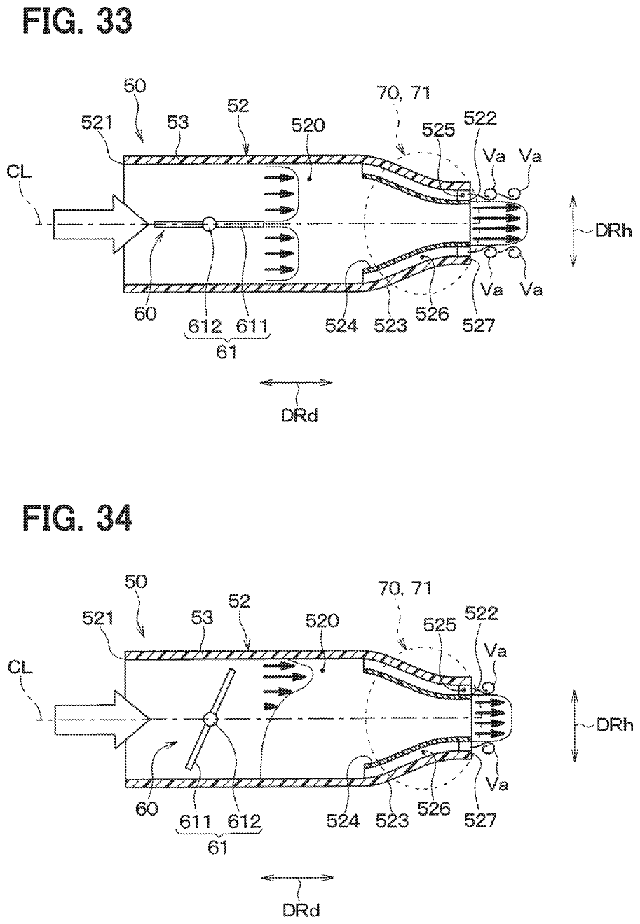

Next, a ninth embodiment will be described with reference to FIGS. 33 to 36. In this embodiment, parts different from the first embodiment will be mainly described.

As shown in FIGS. 33 and 34, the duct portion 52 has a double pipe structure downstream of the passage variable portion 53. The double pipe structure has an outer wall portion 523 and an inner wall portion 524. An adjustment door 61 is arranged in the passage variable portion 53.

The outer wall portion 523 constitutes a part of the outer shell of the duct portion 52, and is connected to the passage variable portion 53. The outer wall portion 523 is shaped to correspond to the inner wall portion 524 so that a substantially constant gap is formed between the outer wall portion 523 and the inner wall portion 524.

The inner wall portion 524 forms the air passage 520 and the outlet 522, and is arranged inside the outer wall portion 523. The inner wall portion 524 is tapered so that the passage area of the air passage 520 is larger at the downstream of the passage variable portion 53 than the opening area of the outlet 522. In the duct portion 52 of this embodiment, the enlarged portion 71 is formed by the inner wall portion 524. The passage area of the air passage 520 is larger at the enlarged portion 71 downstream of the passage variable portion 53 than the opening area of the outlet 522.

An auxiliary passage 526 is formed between the outer wall portion 523 and the inner wall portion 524 so as to allow an air flow to flow in parallel with the air flow flowing through the air passage 520. A part of the air flow that has passed through the passage variable portion 53 flows into the auxiliary passage 526.

The outer wall portion 523 and the inner wall portion 524 are connected to each other by a connecting wall portion 525. The connecting wall portion 525 is provided at a downstream end that forms the outlet 522. The connecting wall portion 525 is a peripheral portion surrounding the outlet 522.

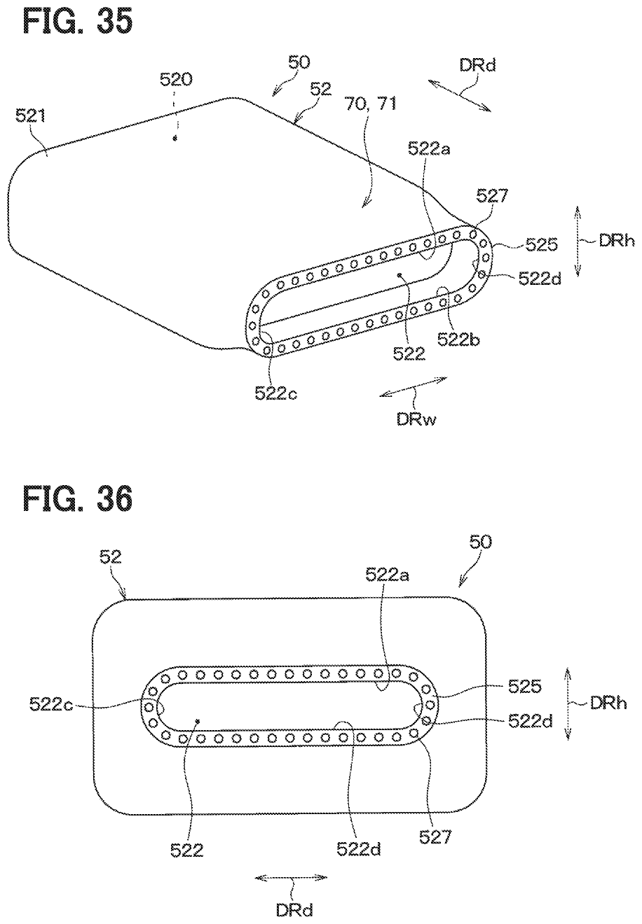

As shown in FIG. 35 and FIG. 36, a blowout port 527 is provided in the connecting wall portion 525 to blow out an auxiliary vortex Va having a vortex characteristic different from a lateral vortex generated downstream of the outlet 522 in the rotation direction and the axis direction of the vortex. The blowout port 527 has a smaller opening shape than the outlet 522. Plural blowout ports 527 are provided in the connecting wall portion 525 so as to surround the outlet 522.

Specifically, the blowout ports 527 are arranged at a constant interval over the entire connecting wall portion 525. The opening shape of the blowout port 527 is circular. The blowout port 527 may be formed in a part of the connecting wall portion 525. Moreover, the opening shape of the blowout port 527 may be a shape other than a circular shape.

In the duct portion 52 configured in this way, the enlarged portion 71 is provided downstream of the passage variable portion 53, so that the air flow that has flowed into the air passage 520 from the passage variable portion 53 contracts at the enlarged portion 71, and is rectified by the contracted flow. As a result, the attenuation of the flow velocity in the central portion of the air flow is suppressed, so that the distance for the air flow blown out from the outlet 522 to reach can be increased.

The auxiliary passage 526 is provided downstream of the passage variable portion 53. Therefore, a part of the air flow that has passed through the passage variable portion 53 flows into the auxiliary passage 526. The air flow flowing through the auxiliary passage 526 is blown out from the blowout port 527. At this time, an auxiliary vortex Va is generated. The auxiliary vortex Va is different from the lateral vortex in terms of at least one of the rotation direction and the axis direction of the vortex. According to this, the auxiliary vortex Va collides with the lateral vortex downstream of the outlet 522, thereby disturbing the lateral vortex, In addition, the auxiliary vortex Va collides with the lateral vortex, whereby the development of the lateral vortex can be suppressed.

The other configurations are the same as those of the first embodiment. The air blowing device 50 of this embodiment has the same configuration as that of the first embodiment. Therefore, it is possible to obtain the same operational effect as the first embodiment, which is achieved by the same configuration as that of the first embodiment.

In the present embodiment, the blowout port 527 is provided, and the auxiliary vortex Va collides with the lateral vortex downstream of the outlet 522, whereby the lateral vortex can be disturbed. In addition, the auxiliary vortex Va collides with the lateral vortex, whereby the development of the lateral vortex can be suppressed. Therefore, it is difficult for a staggered vortex to be formed downstream of the outlet 522, and the meandering flow of the air flow is suppressed at the downstream of the outlet 522.

### Modification of the Ninth Embodiment

In the ninth embodiment, the air blowing device 50 has the passage variable device 60 including the adjustment door 61 and the guiding structure 70 including the enlarged portion 71, but the air blowing device 50 is not limited to this. In the air blowing device 50, for example, one of the passage variable device 60 and the guiding structure 70 may be configured by one other than the ninth embodiment.

### Tenth Embodiment

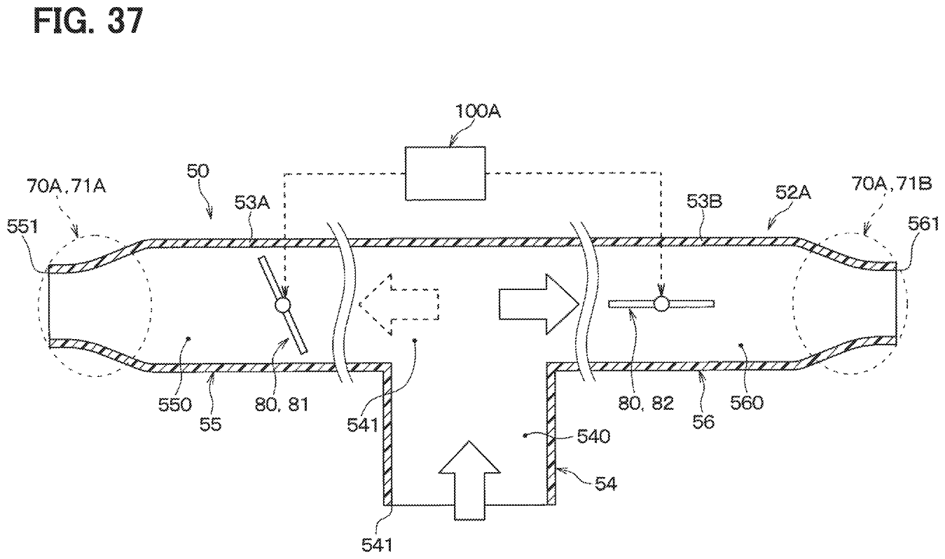

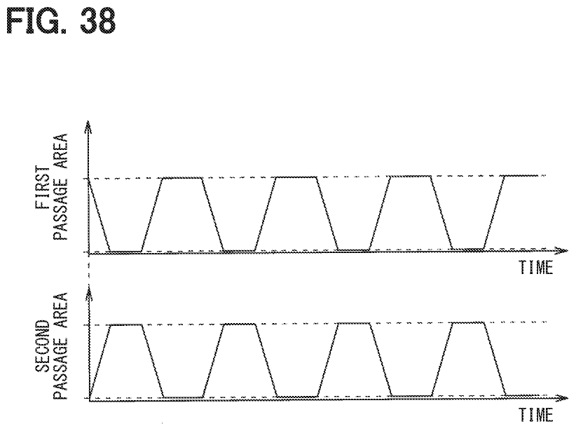

Next, a tenth embodiment will be described with reference to FIGS. 37 and 38. In this embodiment, parts different from the first embodiment will be mainly described.

As shown in FIG. 37, the duct portion 52A has a mainstream pipe 54 forming a main passage 540 through which the air flow passes, and a first branch pipe 55 and a second branch pipe 56 forming a first branch passage 550 and a second branch passage 560, respectively, branched from the main passage 540. The mainstream pipe 54, the first branch pipe 55, and the second branch pipe 56 are connected to each other so that the overall shape has T-shape. The mainstream pipe 54, the first branch pipe 55, and the second branch pipe 56 may be connected so that the overall shape has Y-shape.

The mainstream pipe 54 has an inlet 521 for introducing air conditioned by the indoor air conditioning unit 1 into the main passage 540 located on the upstream side in the air flow. The first branch pipe 55 and the second branch pipe 56 are connected to the connecting portion 541 of the mainstream pipe 54, on the downstream side in the air flow.

The first branch pipe 55 and the second branch pipe 56 are comprised by a pipe with the same shape. The first branch pipe 55 and the second branch pipe 56 are connected to the connecting portion 541 of the mainstream pipe 54 at the downstream side in the air flow.

The first branch pipe 55 has the first outlet 551 located on the downstream side in the air flow. The opening shape of the first outlet 551 is flat like the outlet 522 described in the first embodiment.

The second branch pipe 56 has the second outlet 561 located on the downstream side in the air flow. The opening shape of the second outlet 561 is flat like the outlet 522 described in the first embodiment.

The duct portion 52A includes the passage variable device 80 configured to change the passage area of at least one of the first branch passage 550 and the second branch passage 560 so that the airflow becomes a pulsating flow and is blown out from the first outlet 551 and the second outlet 561.

The passage variable device 80 includes a first opening/closing door 81 that opens/closes the first branch passage 550, a second opening/closing door 82 that opens/closes the second branch passage 560, a drive unit (not shown), and a door control unit 100A. The first opening/closing door 81 and the second opening/closing door 82 are configured similarly to the adjustment door 61 described in the first embodiment.

The first opening/closing door 81 can be set to an open posture that opens the first branch passage 550 and a closed posture that closes the first branch passage 550. The second opening/closing door 82 can be set to an open position that opens the second branch passage 560 and a closed position that closes the second branch passage 560. In the duct portion 52A of the present embodiment, the area where the first opening/closing door 81 is located corresponds to the passage variable portion 53A, the area where and the second opening/closing door 82 is located corresponds to the passage variable portion 53B.

The drive unit is configured to change the postures of the first opening/closing door 81 and the second opening/closing door 82. The drive unit changes the postures of the first opening/closing door 81 and the second opening/closing door 82 so that the passage areas of the first branch passage 550 and the second branch passage 560 change periodically. The drive unit is composed of, for example, an electric actuator such as a stepping motor. The drive unit is controlled according to a control signal from the door control unit 100A.

The door control unit 100A is composed of a computer including a processor and a memory and its peripheral circuits. The door control unit 100A performs various calculations and processes based on the program stored in the memory, and controls the drive unit 62 connected to the output side. The memory of the door control unit 100A is composed of a non-transitory tangible storage medium.

The door control unit 100A is configured separately from an air conditioner ECU (not shown) that controls components of the indoor air conditioning unit 1. Note that the door control unit 100A may be configured as a part of the air conditioner ECU.

As shown in FIG. 38, the door control unit 100A controls the drive unit such that the passage area of the first branch passage 550 (that is, the first passage area) and the passage area of the second branch passage 560 (that is, the second passage) change alternately. Specifically, the door control unit 100A controls the drive unit such that the second branch passage 560 becomes the minimum when the first branch passage 550 is the maximum and that the second branch passage 560 becomes the maximum when the first branch passage 550 is the minimum. The door control unit 100A controls the drive unit so that the switching cycle for switching the posture of the first opening/closing door 81 and the posture of the second opening/closing door 82 is, for example, about 0.1 to 2 seconds. As a result, the air flows blown out from the first outlet 551 and the second outlet 561 change periodically in the flow velocity of the main flow (for example, the average flow velocity).

Further, the duct portion 52A includes the guiding structure 70A for making the flow velocity distribution of the air flow uniform on the downstream side of the first opening/closing door 81 and the second opening/closing door 82 of the passage variable device 80. The guiding structure 70A includes a first enlarged portion 71A and a second enlarged portion 71B provided in the first branch pipe 55 and the second branch pipe 56 respectively.

The passage area of the first branch passage 550 is larger at the first enlarged portion 71A downstream of the passage variable portion 53A than the opening area of the first outlet 551. The passage area of the second branch passage 560 is larger at the second enlarged portion 71B downstream of the passage variable portion 53B than the opening area of the second outlet 561. The first enlarged portion 71A and the second enlarged portion 71B are configured similarly to the enlarged portion 71 described in the first embodiment.

The first enlarged portion 71A and the second enlarged portion 71 B are provided downstream of the passage variable portion 53 in the duct portion 52A. Therefore, the air flow that has passed through the passage variable portion 53 is contracted at the first enlarged portion 71A and the second enlarged portion 71B, and is rectified by the contracted flow.

Next, the operation of the air blowing device 50 will be described. When the blower 8 of the indoor air conditioning unit 1 starts to operate, temperature-controlled air is introduced from the indoor air conditioning unit 1 to the air blowing device 50. The air introduced into the air blowing device 50 is blown into the cabin from at least one of the first outlet 551 and the second outlet 561 via the duct portion 52A.

In the air blowing device 50 of the present embodiment, the passage variable device 80 periodically changes the passage area of the first branch passage 550 and the second branch passage 560 so that the air flow becomes a pulsating flow and is blown out from the first outlet 551 and the second outlet 561.

According to this, the air flow is blown out as a pulsating flow from the first outlet 551 and the second outlet 561. When the air flow blown out from the first outlet 551 and the second outlet 561 becomes a pulsating flow, the position, the size, etc, of the lateral vortex downstream of the first outlet 551 and the second outlet 561 change. Therefore, a staggered vortex is less likely to be formed downstream of the first outlet 551 and the second outlet 561 and the air flow is suppressed from becoming a meandering flow at the downstream of the first outlet 551 and the second outlet 561. Therefore, according to the air blowing device 50 of the present embodiment, it is possible to increase the distance to which the air flow reaches from the first outlet 551 and the second outlet 561.

In addition, the guiding structure 70A for equalizing the flow velocity distribution of the air flow is provided downstream of the passage variable portion 53A, 53B in the duct portion 52A of the air blowing device 50. According to this, the guiding structure 70A makes the flow velocity distribution uniform in the first branch passage 550 and the second branch passage 560 while the passage variable device 80 biases the distribution. For this reason, the air flows blown out from the first outlets 551 and the second outlets 561 are stabilized, so that the distance to which the air flow reaches from the first outlets 551 and the second outlets 561 can be increased.

Specifically, the guiding structure 70 includes the first enlarged portion 71A and the second enlarged portion 71B.

According to this, the air flow from the first enlarged portion 71A and the second enlarged portion 71B toward the first outlet 551 and the second outlet 561 becomes a contracted flow, so that the flow velocity difference is reduced between the vicinity of the central axis of the main flow and the vicinity of the inner surface of the duct portion 52A. As a result, the attenuation of the flow velocity in the central portion of the air flow is suppressed, so that the distance to which the air flow reaches from the first outlet 551 and the second outlet 561 can be increased.

### Modification of the Tenth Embodiment

In the tenth embodiment, the air blowing device 50 has the passage variable device 80 including the first opening/closing door 81 and the second opening/closing door 82, and the guiding structure 70A including the first enlarged portion 71A and the second enlarged portion 71B, but is not limited to this. In the air blowing device 50, one of the passage variable device 80 and the guiding structure 70A may be configured by one other than the tenth embodiment.

In the tenth embodiment described above, as the duct portion 52A, the main passage 540 branches into the first branch passage 550 and the second branch passage 560, but the duct portion 52A is not limited to this. In the duct portion 52A, the main passage 540 may be branched into three or more branch passages. The same also applies to the following embodiments.

In the tenth embodiment described above, as the passage variable device 80, the first branch passage 550 and the second branch passage 560 alternately open and close, but are not limited. The passage variable device 80 may alternately increase or decrease the passage area of the first branch passage 550 and the passage area of the second branch passage 560. The same also applies to the following embodiments.

### Eleventh Embodiment

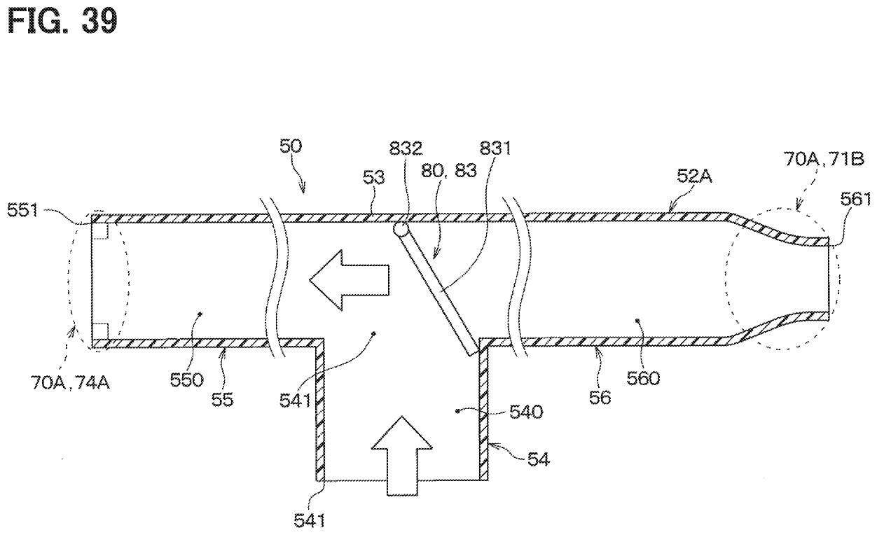

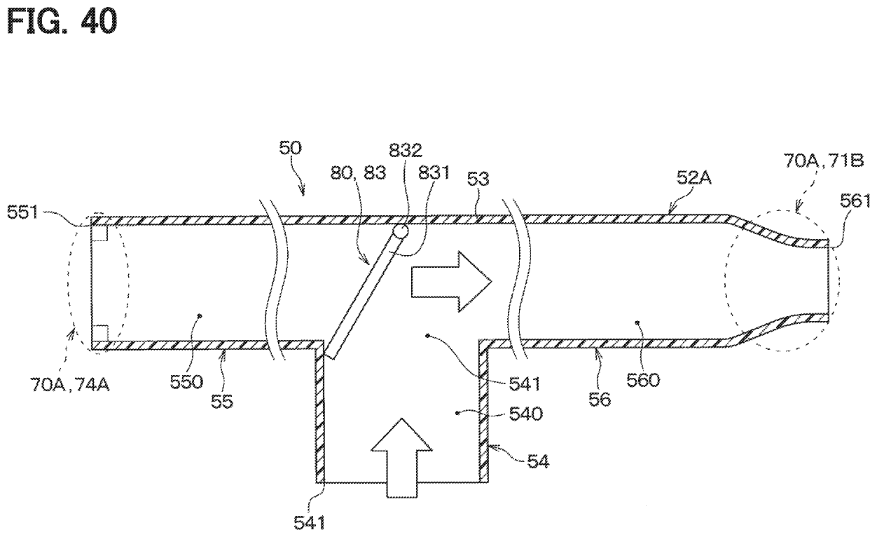

Next, an eleventh embodiment will be described with reference to FIGS. 39 and 40. In the present embodiment, parts different from the tenth embodiment will be mainly described.

As shown in FIGS. 39 and 40, the passage variable device 60 includes an adjustment door 83 for adjusting the passage areas of the first branch passage 550 and the second branch passage 560. The adjustment door 83 is configured by a cantilever rotary door having a plate-shaped door portion 831 and a door shaft 832 connected to one end of the door portion 831.

The adjustment door 83 can be set to a first posture in which the door portion 831 opens the first branch passage 550 and closes the second branch passage 560, and a second posture in which the door portion 831 closes the first branch passage 550 and opens the second branch passage 560.

The first branch passage 550 has the maximum passage area as shown in FIG. 39 when the adjustment door 83 is in the first posture. At this time, the second branch passage 560 is closed by the adjustment door 83, so that the passage area is minimized. When the adjustment door 83 is in the second posture, as shown in FIG. 40, the first branch passage 550 is closed by the adjustment door 83, such that the passage area becomes the minimum. At this time, the passage area of the second branch passage 560 becomes maximum.

A vortex generator 74A is arranged in the first branch pipe 55 instead of the first enlarged portion 71A. The vortex generator 74A is arranged downstream of the passage variable portion 53 and inside the duct portion to be continuous with the first outlet 551. The vortex generator 74A includes, for example, the serration portion 741 described in the sixth embodiment and the block body 742 described in the seventh embodiment. In the present embodiment, the vortex generator 74A and the second enlarged portion 71B form the guiding structure 70A.

The other configurations are the same as those of the tenth embodiment. The air blowing device 50 of this embodiment has the same configuration as that of the tenth embodiment. For this reason, it is possible to obtain the same operational effects as the tenth embodiment achieved by the same configuration as that of the tenth embodiment.

The passage variable device 80 of the present embodiment is configured such that opening and closing of the first branch passage 550 and opening and closing of the second branch passage 560 are realized by the single adjustment door 83. According to this, the air blowing device 50 can be simplified.

Further, the air blowing device 50 of the present embodiment includes the vortex generator 74A provided as the guiding structure 70A, so that the air flow having the top hat velocity distribution is blown from the first outlet 551. According to this, the attenuation of the flow velocity is suppressed in the central portion of the air flow blown out from the first outlet 551, so that the distance where the air flow arrives from the first outlet 551 can be increased. In addition, the auxiliary vortex collides with the lateral vortex downstream of the first outlet 551, whereby the lateral vortex can be disturbed. In addition, the auxiliary vortex collides with the lateral vortex, so that the development of the lateral vortex can be suppressed. Therefore, it becomes difficult for a staggered vortex to be formed downstream of the first outlet 551, and it is possible to suppress the meandering flow of the air flow at the downstream of the first outlet 551.

### Modification of the Eleventh Embodiment

In the eleventh embodiment, the air blowing device 50 has a combination of the passage variable device 80 including the adjustment door 83 and the guiding structure 70A including the vortex generator 74A and the second enlarged portion 71B, but is not limited to this. In the air blowing device 50, for example, one of the passage variable device 80 and the guiding structure 70A may be configured by one other than the eleventh embodiment.

### Twelfth Embodiment

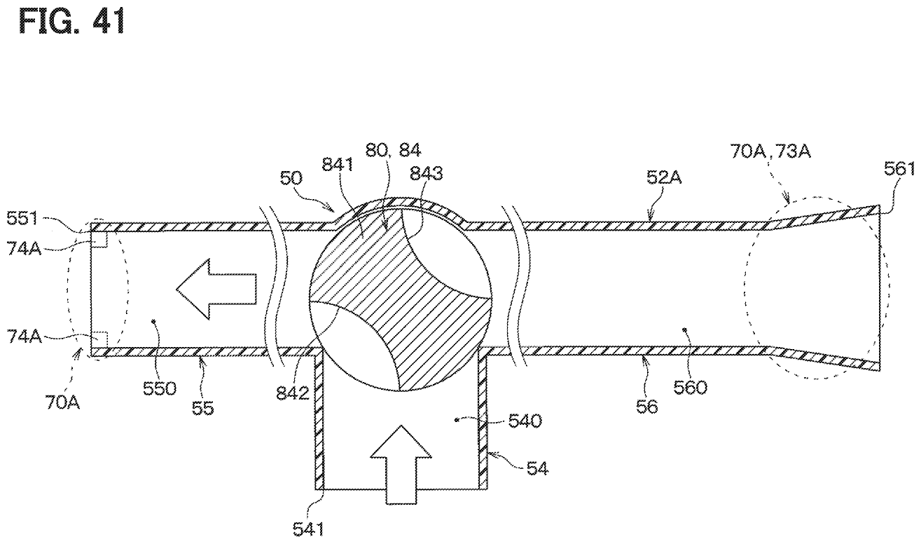

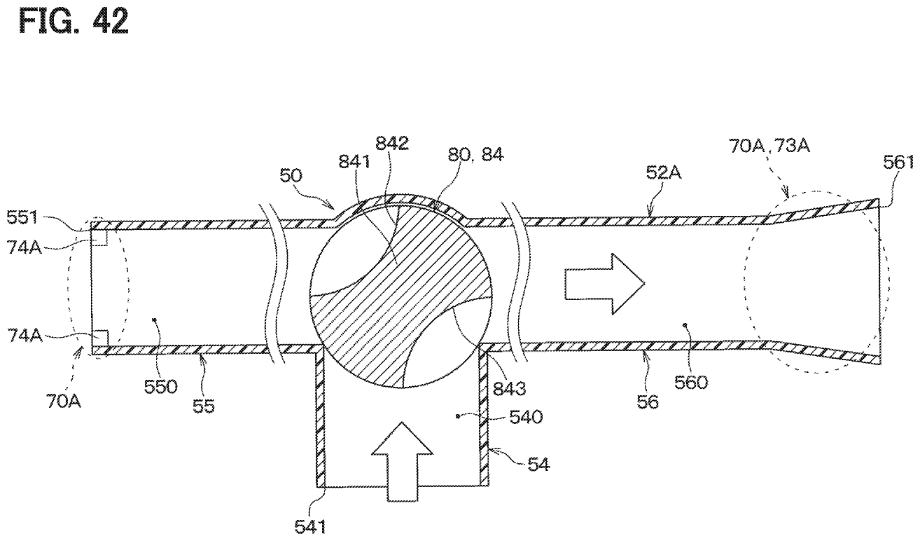

Next, a twelfth embodiment will be described with reference to FIGS. 41 and 42. In this embodiment, parts different from the eleventh embodiment will be mainly described.

As shown in FIGS. 41 and 42, the passage variable device 80 has an adjustment structure 84 instead of the adjustment door 83 of the eleventh embodiment. The adjustment structure 84 includes a columnar portion 841 having a substantially columnar shape and a shaft (not shown).

The columnar portion 841 is arranged at a location in the duct portion 52A where the main passage 540 branches into the first branch passage 550 and the second branch passage 560. The columnar portion 841 has a first communication groove 842 that communicates the main passage 540 and the first branch passage 550, and a second communication groove 843 that communicates the main passage 540 and the second branch passage 560. The first communication groove 842 and the second communication groove 843 are formed so as to form a pair with the central axis of the columnar portion 841 interposed therebetween. That is, the first communication groove 842 is formed at a position opposite to the second communication groove 843 across the central axis of the columnar portion 841. The first communication groove 842 and the second communication groove 843 have a size that allows the air flow flowing through the main passage 540 to pass through.

The adjustment structure 84 can be set to a first posture in which the main passage 540 and the first branch passage 550 communicate with each other, and a second posture in which the main passage 540 and the second branch passage 560 communicate with each other,

When the adjustment structure 84 is in the first posture, the passage area of the first branch passage 550 is large, as shown in FIG. 41. When the adjustment structure 84 is in the second posture, as shown in FIG. 42, the first branch passage 550 is closed by the columnar portion 841 such that the passage area is minimized.

As shown in FIG. 41, when the adjustment structure 84 is in the first posture, the passage area of the second branch passage 560 is minimized by being closed by the columnar portion 841. As shown in FIG. 42, when the adjustment structure 84 is in the second posture, the passage area of the adjustment structure 84 is increased.

The second branch pipe 56 has a flare portion 73A instead of the second enlarged portion 71B. The flare portion 73A is formed downstream of the passage variable portion 53 to be continuous with the second outlet 561. The flare portion 73A is, for example, the flare portion 73 described in the third embodiment. In this embodiment, the vortex generator 74A and the flare portion 73A form the guiding structure 70A.

The other configurations are the same as those of the eleventh embodiment. The air blowing device 50 of this embodiment has the same configuration as that of the eleventh embodiment. Therefore, it is possible to obtain the same operational effect as the eleventh embodiment obtained from the same configuration as that of the eleventh embodiment.

The passage variable device 80 of the present embodiment is configured such that opening and closing of the first branch passage 550 and opening and closing of the second branch passage 560 are realized by the single adjustment structure 84. According to this, the air blowing device 50 can be simplified.

The air blowing device 50 of the present embodiment has the flare portion 73A provided as the guiding structure 70A, so that the air flow that has passed through the passage variable portion 53B is rectified. For this reason, the attenuation of the flow velocity in the central portion of the air flow is suppressed, so that the distance to which the air flow reaches from the second outlet 561 can be increased.

### Modification of the Twelfth Embodiment

In the twelfth embodiment, the air blowing device 50 has a combination of the passage variable device 80 including the adjustment structure 84 and the guiding structure 70A including the vortex generator 74A and the flare portion 73A, but is not limited to this. In the air blowing device 50, for example, one of the passage variable device 80 and the guiding structure 70A may be configured by one other than the twelfth embodiment.

### Thirteenth Embodiment

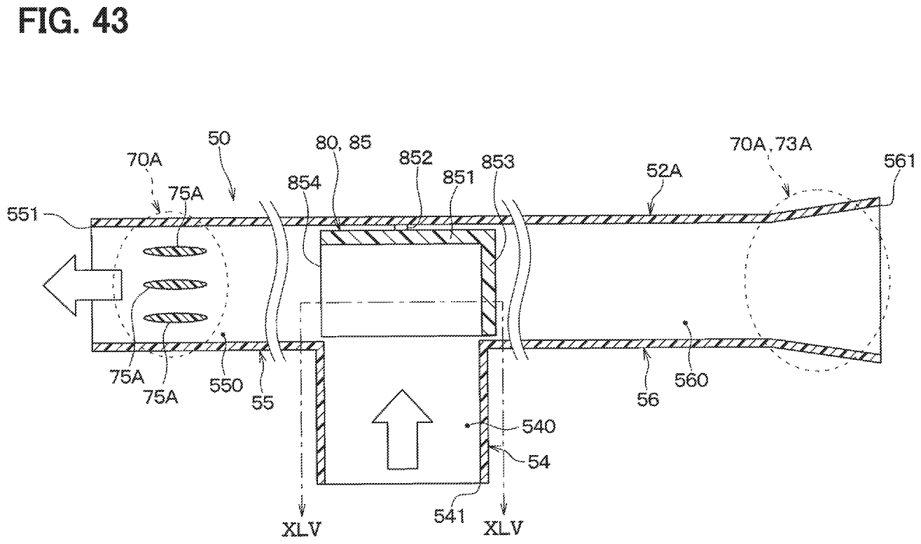

Next, a thirteenth embodiment will be described with reference to FIGS. 43 to 46. In the present embodiment, parts different from the twelfth embodiment will be mainly described.

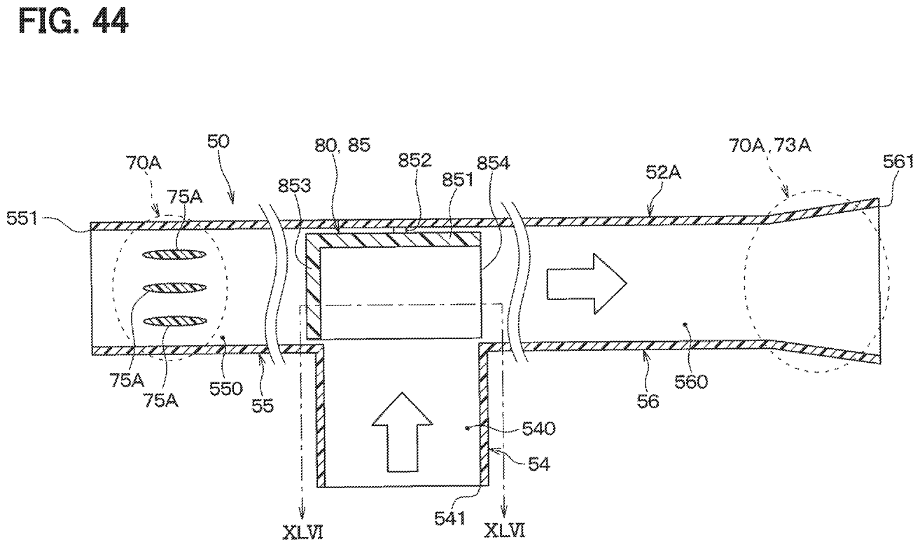

As shown in FIGS. 43 and 44, the passage variable device 80 includes a rotary door 85 for adjusting the passage areas of the first branch passage 550 and the second branch passage 560. The rotary door 85 has a bottomed cylindrical tubular portion 851 and a shaft 852.

The tubular portion 851 has a side wall portion 853 that faces the first branch passage 550 and the second branch passage 560. A communication hole 854 is formed in the side wall portion 853 so that the inside and outside of the tubular portion 851 can communicate with each other. The tubular portion 851 is located in the duct portion 52A where the main passage 540 is branched into the first branch passage 550 and the second branch passage 560 so that the air flow flowing through the main passage 540 flows into the side wall portion 853.

The rotary door 85 can be set to a first posture in which the communication hole 854 faces the first branch passage 550 and a second posture in which the communication hole 854 faces the second branch passage 560.

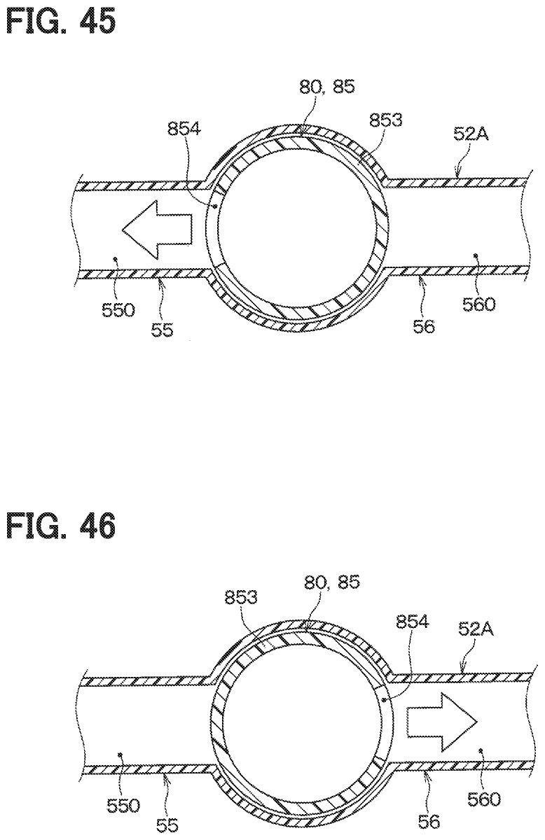

The first branch passage 550 has a larger passage area when the rotary door 85 is in the first posture as shown in FIGS. 43 and 45. When the rotary door 85 is in the second posture as shown in FIGS. 44 and 46, the passage area is minimized.

As shown in FIGS. 43 and 45, when the rotary door 85 is in the first posture, the passage area of the second branch passage 560 is the minimum. When the rotary door 85 is in the second posture, as shown in FIGS. 44 and 46, the passage area of the second branch passage 560 becomes large.

Plural fins 75A are arranged in the first branch pipe 55, instead of the vortex generator 74A. The fin 75A is arranged so as to cross the first branch passage 550. The fin 75A is the same as, for example, the fin 75 described in the eighth embodiment. In the present embodiment, the fin 75A constitutes the guiding structure 70A.

The other configurations are the same as those of the twelfth embodiment. The air blowing device 50 of this embodiment has the same configuration as that of the twelfth embodiment, For this reason, it is possible to obtain the same operational effects as the twelfth embodiment obtained from the same configuration as that of the twelfth embodiment.

The passage variable device 80 of the present embodiment is configured such that opening and closing of the first branch passage 550 and opening and closing of the second branch passage 560 are realized by the single rotary door 85. According to this, the air blowing device 50 can be simplified.

The air blowing device 50 of the present embodiment includes the fins 75A provided as the guiding structure 70A, so that the air flow that has passed through the passage variable portion 53A is rectified. For this reason, the attenuation of the flow velocity in the central portion of the air flow is suppressed, so that the air flow blown out from the first outlet 551 can reach a farther position.

### Modification of the Thirteenth Embodiment

In the thirteenth embodiment, the air blowing device 50 has a combination of the passage variable device 80 including the rotary door 85 and the guiding structure 70A including the fins 75A and the flare portions 73A, but is not limited to, In the air blowing device 50, for example, one of the passage variable device 80 and the guiding structure 70A may be configured by one other than the thirteenth embodiment.

### Other Embodiments

Although representative embodiments of the present disclosure have been described above, the present disclosure is not limited to the embodiments described above, and various modifications can be made, for example, as follows.

As in the above embodiments, the air blowing device 50 includes the guiding structure 70, 70A, but is not limited. In the air blowing device 50, the guiding structure 70, 70A may be omitted.

In the embodiments, as the opening shape of the outlet 522, the straight long edges 522a and 522b and the arc-shaped short edges 522c and 522d are continuous. Alternatively, for example, the opening shape of the outlet 522 may be formed by arc-shaped long edges 522a and 522b and straight short edges 522c and 522d which are continuous. The opening shape of the outlet 522 may be a rectangular shape having straight long edges 522a and 522b and straight short edges 522c and 522d.

In the embodiments, the opening shape of the outlet 522 is a flat shape, but is not limited to this. For example, the opening shape of the outlet 522 may be circular, elliptical, or polygonal.

In the embodiments, the air blowing device 50 of the present disclosure is applied to the indoor air conditioning unit 1, but is not limited to this. The air blowing device 50 of the present disclosure is widely applicable to air conditioning equipment other than the indoor air conditioning unit 1, blowers used for other than air conditioning.

In the embodiments, it is needless to say that the elements configuring the embodiments are not necessarily essential except in the case where those elements are clearly indicated to be essential in particular, the case where those elements are considered to be obviously essential in principle, and the like.

In the embodiments, the present disclosure is not limited to the specific number of components of the embodiments, except when numerical values such as the number, numerical values, quantities, ranges, and the like are referred to, particularly when it is expressly indispensable, and when it is obviously limited to the specific number in principle, and the like.

In the embodiments, when referring to the shape, positional relationship, and the like of a component and the like, the present disclosure is not limited to the shape, positional relationship, and the like, except for the case of being specifically specified, the case of being fundamentally limited to a specific shape, positional relationship, and the like, and the like.

### (Overview)

According to the first aspect shown in part or all of the above-described embodiments, the air blowing device includes a duct portion that forms a main passage, and a passage variable device that changes the passage area of the main passage, such that an air flow becomes a pulsating flow and is blown out of an outlet of the duct portion.

According to the second aspect, the duct portion includes a guiding structure to make the flow velocity distribution of the airflow uniform, downstream of the passage variable portion where the passage area is changed by the passage variable device.

When the passage area of the main passage is changed by the passage variable device, the flow velocity distribution of the air flow tends to be biased downstream of the passage variable portion in the duct portion. If the flow velocity distribution is biased, the air flow blown from the outlet may not be stable, and the distance to which the air flow reaches from the outlet may be shortened.

When the guiding structure is provided downstream of the passage variable portion in the duct portion, the airflow blown out from the outlet becomes stable, so that the distance to which the air flow reaches from the outlet can be increased.

According to the third aspect, the duct portion has an enlarged portion where the passage area of the main passage is larger than the opening area of the outlet. The enlarged portion is located in a part of an area from the passage variable portion where the passage area is changed by the passage variable device to the outlet. The guiding structure includes the enlarged portion.

According to this, due to the contraction of the air flow from the enlarged portion to the outlet, the difference in flow velocity between the central axis of the main flow and the inner surface of the duct portion becomes small, and the thickness of the velocity boundary layer formed near the inner surface of the duct portion can be reduced. As a result, the attenuation of the flow velocity in the central portion of the air flow is suppressed, so that the distance to which the air flow reaches from the outlet can be increased.

According to the fourth aspect, the duct portion has the enlarged portion where the passage area of the main passage is larger than the opening area of the outlet. The enlarged portion is located in a part of an area from the passage variable portion where the passage area is changed by the passage variable device to the outlet. Further, the duct portion has a flare portion located downstream of the enlarged portion to be continuous with the outlet such that the inner surface forming the main passage separates from the central axis of the main passage as approaching the outlet. The guiding structure includes the enlarged portion and the flare portion.

According to this, due to the contraction of the air flow from the enlarged portion to the outlet, the difference in flow velocity between the central axis of the main flow and the inner surface of the duct portion becomes small, and the thickness of the velocity boundary layer formed near the inner surface of the duct portion can be reduced. In addition, the velocity boundary layer of the air flow downstream of the outlet is likely to be formed away from the central axis of the outlet in accordance with the shape of the inner wall surface to be continuous with the outlet. As a result, the attenuation of the flow velocity in the central portion of the air flow is suppressed, so that the distance to which the air flow reaches from the outlet can be increased.

According to the fifth aspect, the duct portion has the flare portion where the inner surface forming the main passage is separated from the central axis of the main passage as approaching the outlet to be continuous with the outlet. The guiding structure includes the flare portion.

According to this, the velocity boundary layer of the air flow formed downstream of the outlet is easily formed away from the central axis of the outlet according to the shape of the inner wall surface to be continuous with the outlet. This suppresses the attenuation of the flow velocity in the central portion of the air flow, so that the distance to which the air flow reaches from the outlet can be increased.

According to the sixth aspect, the passage variable device is configured to change the passage area of the main passage, when reducing the passage area of the main passage, such that a throat passage is formed between the contracted slope portion and the enlarged slope portion, where the passage area of the main passage becomes the minimum. The enlarged slope portion is formed downstream of the contracted slope portion and the throat passage in the duct portion, to be continuous with the outlet. The passage area of the main passage continuously decreases at the contracted slope portion when the passage area of the main passage is reduced. The passage area of the main passage increases continuously at the enlarged slope portion when the passage area of the main passage is reduced.

According to this, when the passage area of the main passage is changed by the passage variable device, the air flow heading from the contracted slope portion to the throat passage becomes the contracted flow. Therefore, the difference in the flow velocity between the vicinity of the central axis of the main flow and the vicinity of the inner surface of the duct portion becomes small, and the thickness of the velocity boundary layer formed near the inner surface of the duct portion can be reduced. In addition, when the passage variable device changes the passage area of the main passage, the enlarged slope portion is formed to be continuous with the outlet. According to this, the velocity boundary layer of the air flow downstream of the outlet is easily formed away from the central axis of the outlet according to the shape of the inner wall surface to be continuous with the outlet. Accordingly, since the attenuation of the flow velocity in the central portion of the air flow is suppressed, it is possible to increase the distance where the air flow reaches from the outlet.

According to the seventh aspect, in the duct portion, the passage variable portion in which the passage area is changed by the passage variable device is made of a material having elasticity. The passage variable device is configured to deform the passage variable portion, when the passage area of the main passage is reduced, so that at least a part of the inner surface of the passage variable portion approaches the central axis of the main passage.

In this way, when the passage variable device deforms the passage variable portion such that at least a part of the inner surface of the passage variable portion approaches the central axis of the main passage, the flow velocity distribution of the air flow is less likely to be biased downstream of the passage variable portion. As a result, since the air flow blown out from the outlet is stabilized, it is possible to increase the distance where the air flow reaches from the outlet.

According to the eighth aspect, the guiding structure includes the vortex generator arranged inside the duct portion to be continuous with the outlet. The vortex generator is configured to generate an auxiliary vortex having vortex characteristics different from the lateral vortex generated downstream of the outlet in terms of rotation direction and axis direction of the virtex,

According to this, when the air flow passes around the vortex generator, an auxiliary vortex that is different from the lateral vortex in at least one of the rotation direction and the axis direction of the vortex is generated. In such a structure, since the air flow flowing inside the outlet is rectified by the auxiliary vortex, the thickness of the velocity boundary layer formed inside the outlet can be reduced.

In addition, the auxiliary vortex collides with the lateral vortex downstream of the outlet so that the lateral vortex can be disturbed. Further, the auxiliary vortex collides with the lateral vortex, so that the development of the lateral vortex can be suppressed. Therefore, it becomes difficult for a staggered vortex to be formed downstream of the outlet, and it is possible to restrict the air flow from becoming a meandering flow downstream of the outlet. In addition, the vortex characteristics indicate the flow state of the vortex including the rotation direction of the vortex, the axis direction of the vortex, the flow velocity of the vortex, the viscosity of fluid forming the vortex, the radius of the vortex, and the like.

According to the ninth aspect, the guiding structure includes at least one fin arranged so as to cross the main passage. According to this, the fin traversing the main passage can stabilize the air flow blown out from the outlet, so that it is possible to increase the distance where the air flow reaches from the outlet.

According to the tenth aspect, the duct portion has an auxiliary outlet that blows out an auxiliary vortex having a vortex characteristic different from a lateral vortex generated downstream of the outlet in terms of a rotation direction and an axis direction of the vortex. According to this, the auxiliary vortex collides with the lateral vortex downstream of the outlet, thereby disturbing the lateral vortex. In addition, the auxiliary vortex collides with the lateral vortex, so that the development of the lateral vortex can be suppressed. Therefore, it becomes difficult for a staggered vortex to be formed downstream of the outlet, and it is possible to restrict the air flow from becoming a meandering flow downstream of the outlet.

According to the eleventh aspect, the air blowing device includes a duct portion that forms a main passage and plural branch passages, and a passage variable device configured to change the passage area of the branch passage such that an air flow becomes a pulsating flow and is blown out from an outlet of the duct portion.

According to the twelfth aspect, the guiding structure for equalizing the flow velocity distribution of the air flow is provided downstream of the passage variable portion where the passage area is changed by the passage variable device in the duct portion. In this way, when the guiding structure is provided downstream of the passage variable portion in the duct portion, the air flow blown out from the outlet becomes stable, so that it is possible to increase the distance where the air flow reaches from the outlet.

What is claimed is:

1. An air blowing device comprising:
a duct portion that forms a main passage through which an air flow passes, an outlet being defined downstream of the main passage to blow out the air flow; and
a passage variable device configured to change a passage area of the main passage so that the air flow becomes a pulsating flow and is blown out from the outlet.

2. The air blowing device according to claim 1, further comprising
a guiding structure provided in the duct portion to make a velocity distribution of the air flow uniform, the guiding structure being located downstream of a passage variable portion of the duct portion where the passage area is changed by the passage variable device.

3. The air blowing device according to claim 2, wherein
the duct portion has an enlarged portion where the passage area of the main passage is larger than an open area of the outlet at a location between the passage variable portion and the outlet, and
the guiding structure includes the enlarged portion.

4. The air blowing device according to claim 2, wherein
the duct portion has an enlarged portion where the passage area of the main passage is larger than an open area of the outlet at a location between the passage variable portion and the outlet,
the duct portion has a flare portion downstream of the enlarged portion to be continuous with the outlet, in which an inner surface of the main passage is separated from a central axis of the main passage as approaching the outlet, and
the guiding structure includes the enlarged portion and the flare portion.

5. The air blowing device according to claim 2, wherein
the duct portion has a flare portion to be continuous with the outlet, in which an inner surface of the main passage is separated from a central axis of the main passage as approaching the outlet, and
the guiding structure includes the flare portion.

6. The air blowing device according to claim 2, wherein
the passage variable device has a contracted slope portion where the passage area of the main passage is continuously reduced and an enlarged slope portion where the passage area of the main passage is continuously increased,
a throat passage is formed between the contracted slope portion and the enlarged slope portion to cause the passage area of the main passage to be the minimum, and
the enlarged slope portion is formed downstream of the contracted slope portion and the throat passage in the duct portion to be continuous with the outlet.

7. The air blowing device according to claim 2, wherein
the passage variable portion of the duct portion is made of a material having elasticity, and
the passage variable device is configured to deform at least a part of the passage variable portion to approach a central axis of the main passage when the passage area of the main passage is reduced.

8. The air blowing device according to claim 2, wherein
the guiding structure includes a vortex generator arranged inside a part of the duct portion that is continuous with the outlet, and
the vortex generator is configured to generate an auxiliary vortex having a vortex characteristic different from a lateral vortex generated downstream of the outlet in terms of a rotation direction and an axis direction of a vortex.

9. The air blowing device according to claim 2, wherein the guiding structure includes at least one fin arranged so as to cross the main passage.

10. The air blowing device according to claim 1, wherein the duct portion has an auxiliary blowout port configured to blow out an auxiliary vortex having a vortex characteristic different from a lateral vortex generated downstream of the outlet in terms of a rotation direction and an axis direction of a vortex.

11. An air blowing device comprising:
a duct portion that forms a main passage through which an air flow passes and a plurality of branch passages branched from the main passage, an outlet being defined downstream of the respective branch passages to blow out the air flow; and
a passage variable device configured to change a passage area of at least a part of the plurality of branch passages so that the air flow becomes a pulsating flow and is blown out from the outlet.

12. The air blowing device according to claim 11, further comprising
a guiding structure provided in the duct portion to make a velocity distribution of the air flow uniform, the guiding structure being located downstream of a passage variable portion of the duct portion where the passage area is changed by the passage variable device.
